(19) United States
(12) Patent Application Publication
(10) Pub. No.: US 2006/0141972 A1
(43) Pub. Date: Jun. 29, 2006

(54) Signal processing device and direct conversion reception device

(75) Inventor: Noriaki Matsuno, Tokyo (JP)

Correspondence Address: FOLEY AND LARDNER LLP;SUITE 500, 3000 K STREET NW, WASHINGTON, DC, 20007, US

(73) Assignee: NEC CORPORATION, Tokyo (JP)

(21) Appl. No.: 10/545,671

(22) PCT Filed: Jan. 16, 2004
(86) PCT No.: PCT/JP04/00313

§ 371 Date: Aug. 15, 2005

(30) Foreign Application Priority Data
Feb. 20, 2003 (JP) 2003-042686

(51) Int. Cl. H04B 1/10; H04B 1/26

(52) U.S. Cl. 455/313; 455/303

(57) ABSTRACT

A base band signal input from an input terminal (10) has a DC component which is blocked off by a high pass filter (12). When the signal which has passed through the high pass filter (12) has a voltage out of a predetermined set voltage range, the signal of the voltage portion out of the voltage range is extracted by a signal extraction circuit (15). According to the signal extracted, the DC potential of the base band signal is adjusted at a feedback point (17).

### TECHNICAL FIELD

The present invention relates to a signal processing device and, more particularly, to a technique for a signal processing device capable of removing a DC offset contained in an input signal.

### BACKGROUND ART

Recently, a direct conversion scheme has been known as one of the wireless reception schemes for meeting requirements for, for example, reductions in the size, power consumption, and price of wireless communication devices such as cellular phones.

FIG. 24 is a view showing the general arrangement of a reception device (to be referred to as a “direct conversion reception device” hereinafter) to which the direct conversion scheme is applied. In a direct conversion reception device 100 shown in FIG. 24, an RF (Radio Frequency) signal which is a high-frequency signal received by an antenna 101 is amplified by an LNA (Low Noise Amplifier) 102, and the amplified signal is branched into two paths and received by the RF ports of mixers 103 and 104. The amplified RF signals are respectively down-converted by the mixers 103 and 104. At this time, local signals which are local oscillation signals are input from input terminals 105 and 106 to the local ports of the mixers 103 and 104. These local signals have a phase difference of 90°, and their frequencies are selected to be almost equal to the carrier frequency of a (desired) RF signal to be received. This makes it possible to obtain a baseband signal by one down conversion.

The baseband signals output from the mixers 103 and 104 are respectively amplified by amplifiers 107 and 108. The amplified signals respectively pass through low-pass filters (LPFs) 109 and 110 for channel selection. The baseband signals passing through the low-pass filters 109 and 110 are respectively amplified by amplifiers 111 and 112 and are converted into digital signals by ADCs (Analog to Digital Converters) 113 and 114, respectively.

In this manner, the direct conversion reception device 100 performs down conversion to baseband before signal components other than channel signals are filtered out, and hence sufficient gains cannot be obtained before the mixers 103 and 104 in consideration of interference waves. Therefore, the intensities of desired waves after down conversion are basically low, and the influence of DC (Direct current) offsets on outputs from the mixers 103 and 104 are relatively large.

It is known that a DC offset occurs due to several mechanisms other than the drift of the DC levels of mixer outputs which are caused by variations in elements. FIGS. 25A, 25B, 26A, and 26B show typical examples of DC offset occurrence mechanisms. FIG. 25A shows how a local signal goes round to the RF port of the mixer 103 due to leakage or the like through a path 115. In this case, the going round of such local signals causes a DC offset due to self-mixing of the local signals. This DC offset is a so-called static DC offset which does not vary with time. FIG. 25B shows how a local signal goes round to the RF port of the mixer 103 through a path 116. In this case, as in the case shown in FIG. 25A, a DC offset is caused by the going round of local signals. In this case, the DC offset amount varies depending on gain setting for the LNA 102. The DC offset amount therefore varies at the time of LAN gain setting immediately after the start of the reception of an RF signal. In addition, local signals which have gone round to the input terminal of the LNA 102 flow backward to the antenna 101. Such signals may be temporarily radiated to the space, and then return from the antenna to the LNA 102 and mixer 103 again. The DC offset in this case is a so-called dynamic DC offset which varies with changes in ambient environment or the like.

FIG. 26A shows how some of the RF signals received by the antenna 101 are input to the local port of the mixer 103 through a path 117. In this case, as RF signals are input to the local port, a DC offset is caused by self-mixing of the RF signals. This DC offset noticeably appears when there is a strong interference wave near the frequency band of a desired RF signal. Since the reception intensity of an interference wave varies due to the influence of fading and the like, this DC offset becomes a dynamic DC offset. FIG. 26B shows how some of the RF signals amplified by the LNA 102 go round to the local port of the mixer 103 through a path 118. In this case, the going round of RF signals causes a DC offset due to self-mixing of the RF signals. This DC offset has both the characteristic of a dynamic DC offset due to fading or the like and the characteristic of a static DC offset due to a change in LNA gain. In addition, a DC offset varies due to the secondary distortion of a mixer.

In order to remove the DC offset described above, the methods shown in FIG. 27 and 28 may be used. FIG. 27A shows a method in which a capacitor 119 which cuts off DC components is provided on the output portion of the mixer 103. FIG. 27B shows a method in which a high-pass filter 120 which cuts off DC components is provided on the output portion of the mixer 103. In either of the methods shown in FIGS. 27A and 27B, high-pass characteristics are realized. FIG. 27C shows a method in which a feedback element 121 is added to the amplifier 107 to realize DC servo control. This function corresponds to both a high-pass filter and an amplifier.

FIG. 28 shows a method in which an ADC 122, signal processing unit 123, and DAC 124 are added to make the ADC 122 capture a DC offset amount, make the signal processing unit 123 detect a DC offset amount, and make the DAC 124 generate a signal for canceling out the DC offset. Although FIG. 28 shows a feedforward-type arrangement, a feedback-type arrangement can also be used. In addition, in the method shown in FIG. 28, there is known a method of detecting a DC offset amount in an undesired reception time slot, and fixing a signal for canceling out the DC offset in a desired reception time slot.

Furthermore, a DC offset can be removed by the techniques disclosed in patent references. The reception device disclosed in patent reference 1 (Japanese Patent Laid-Open No. 8-316998) is designed to monitor a reception signal level (reception signal intensity) and decrease the time constant of a high-pass filter only when the level changes by an amount greatly larger than a predetermined amount. This change in reception signal level causes a variation in DC offset due to the secondary distortion of a mixer, a variation in DC offset due to the occurrence of gain switching of a variable gain amplifier. According to the technique in patent reference 1, therefore, a variation in DC offset can be handled. In addition, patent reference 2 (Japanese Patent Laid-Open No. 11-186874) discloses a DC feedback-type high-pass filter comprising an amplifier having an inverting input terminal and non-inverting input terminal and a feedback amplifier which feedback-amplifies an output signal from the amplifier. This feedback amplifier has a nonlinear element which nonlinearly changes to set a low gain for a small-amplitude signal and a high gain for a large-amplitude signal. According to the technique in patent reference 2, this makes it possible to shorten the response time until the output DC level converges.

In the methods shown in FIGS. 27A to 27C, however, part of a (desired) signal component to be received may be lost, and when the DC offset amount varies with time, it is difficult to satisfy both a requirement for the removal of a DC offset and a requirement for the retention of a desired signal component. In order to follow up temporal variations in DC offset due to a dynamic DC offset or the like, a high-pass filter or the like needs to have a high cutoff frequency. If, however, this cutoff frequency is increased, components near DC of desired signal components are also omitted. Depending on the modulation scheme used for reception signals, therefore, the bit error rate (BER) increases to an unacceptable level. According to the method shown in FIG. 28, complicated hardware is required, and it is necessary to generate a control signal synchronized with a reception time slot by using a logical operation circuit and supply the control signal to a circuit which processes analog signals such as RF signals. In addition, this method cannot handle the occurrence of a variation in DC offset in a desired reception time slot.

According to the technique in patent reference 1, a variation in DC offset is indirectly observed and controlled in the form of a variation in reception signal level, and hence this control is not always appropriate. That is, the time constant of the high-pass filter is switched to the smaller one in spite of the fact that there is no variation in DC offset, or the time constant may be kept large in spite of the fact that the DC offset varies, depending on the DC offset occurrence mechanism and detailed conditions. In addition, this technique additionally requires a device which generates a signal for switching the time constant of the high-pass filter upon receiving a detected reception signal level, and hence the device arrangement becomes complicated. According to the technique in patent reference 2, when there is a steady DC offset in an input signal to an amplifier, and, for example, the DC offset voltage contained in the input signal is much higher than the ideal midpoint potential, with a desired signal component smaller in amplitude than the DC offset voltage being superimposed on the input signal, the DC voltage of a feedback signal becomes also much higher than the ideal midpoint potential near the DC offset voltage. That is, the output DC level of the above nonlinear element has a voltage level considerably deviating from the ideal midpoint potential. Therefore, the above nonlinear element is in a high-gain state with respect to a small-amplitude signal, and hence the cutoff frequency of the high-pass filter is kept high. In the technique in patent reference 2, the time constant of the high-pass filter is determined by the absolute value of the DC offset contained in an input signal. That is, the technique cannot obtain the effect of increasing the time constant concurrently with convergence of an output DC level.

As described above, the conventional techniques cannot meet both the requirement for processing of a dynamic DC offset and the requirement for signal transmission without any omission of a (desired) signal component to be received.

### DISCLOSURE OF INVENTION

The present invention has been made in consideration of the above problems, and has as its object to provide a signal processing device and direct conversion reception device which can, for example, meet both the requirement for processing of a dynamic DC offset and the requirement for signal transmission without any omission of a desired signal component to be received.

A signal processing device according to the present invention is characterized by comprising extraction means for extracting a signal corresponding to a voltage portion outside a predetermined voltage range from a processing target signal, and regulation means for regulating a direct current potential of the processing target signal on the basis of the extracted signal and outputting the processing target signal.

In addition, a direct conversion reception device is characterized by comprising mixing means for frequency-mixing a received high-frequency signal and an oscillation signal and converting the resultant signal into a baseband signal, extraction means for extracting a signal corresponding to a voltage portion outside a predetermined voltage range from the baseband signal, and regulation means for regulating a direct current potential of the baseband signal on the basis of the extracted signal.

### BRIEF DESCRIPTION OF DRAWINGS

FIG. 1 is a view showing a schematic arrangement example of a direct conversion reception device according to this embodiment;

FIG. 2 is a view showing a schematic arrangement example of a signal processing circuit 6a of a signal processing device according to the first embodiment;

FIG. 3A is a view showing an example of the arrangement of an active filter;

FIG. 3B is a view showing arrangement example 1 of a signal extraction circuit 15;

FIG. 3C is a view showing the input voltage-current characteristic of the signal extraction circuit 15;

FIG. 4 is a view showing arrangement example 2 of the signal extraction circuit 15;

FIG. 5 is a view showing arrangement example 3 of the signal extraction circuit 15;

FIG. 6 is a view showing a schematic arrangement example of a signal processing circuit 6a of a signal processing device according to the second embodiment;

FIG. 7 is a view showing a schematic arrangement example of a signal processing circuit 6a of a signal processing device according to the third embodiment;

FIG. 8 is a view showing a schematic arrangement example of a signal processing circuit 6a of a signal processing device according to the fourth embodiment;

FIG. 9 is a view showing a schematic arrangement example of a signal processing circuit 6a of a signal processing device according to the fifth embodiment;

FIG. 10 is a view showing a schematic arrangement example of a signal processing circuit 6a of a signal processing device according to the sixth embodiment;

FIG. 11 is a view showing a schematic arrangement example of a signal processing circuit 6a of a signal processing device according to the seventh embodiment;

FIG. 12 is a view showing a schematic arrangement example of a signal processing circuit 6a of a signal processing device according to the eighth embodiment;

FIG. 13 is a view showing a schematic arrangement example of a signal processing circuit 6a of a signal processing device according to the ninth embodiment;

FIG. 14 is a view showing a schematic arrangement example of a signal processing circuit 6a of a signal processing device according to the 10th embodiment;

FIG. 15 is a view showing a schematic arrangement example of a signal processing circuit 6a of a signal processing device according to the 11th embodiment;

FIG. 16 is a view showing a schematic arrangement example of a signal processing circuit 6a of a signal processing device according to the 12th embodiment;

FIG. 17 is a view showing a schematic arrangement example of a signal processing circuit 6a of a signal processing device according to the 13th embodiment;

FIG. 18 is a view showing a schematic arrangement example of a signal processing circuit 6a of a signal processing device according to the 14th embodiment;

FIG. 19 is a view showing a schematic arrangement example of a signal processing circuit 6a of a signal processing device according to the 15th embodiment;

FIG. 20 is a view showing a schematic arrangement example of a signal processing circuit 6a of a signal processing device according to the 16th embodiment;

FIG. 21 is a view showing a schematic arrangement example of a signal processing circuit 6a of a signal processing device according to the 17th embodiment;

FIG. 22 is a view showing a schematic arrangement example of a signal processing circuit 6a of a signal processing device according to the 18th embodiment;

FIG. 23 is a view showing a schematic arrangement example of a signal processing circuit 6a of a signal processing device according to the 19th embodiment;

FIG. 24 is a view showing a general arrangement of a reception device to which a direct conversion scheme is applied;

FIG. 25A is a view showing a main example of a DC offset occurrence mechanism;

FIG. 25B is a view showing another example of the DC offset occurrence mechanism;

FIG. 26A is a view showing a main example of a DC offset occurrence mechanism;

FIG. 26B is a view showing another example of the DC offset occurrence mechanism;

FIG. 27A is a view showing a conventional method of removing a DC offset;

FIG. 27B is a view showing another conventional method of removing a DC offset;

FIG. 27C is a view showing another conventional method of removing a DC offset; and

FIG. 28 is a view showing a conventional method of removing a DC offset.

### BEST MODE FOR CARRYING OUT THE INVENTION

The preferred embodiments of the present invention will be described below with reference to the accompanying drawings. Note that each of the following embodiments is an embodiment in which a signal processing device according to the present invention is applied to a direct conversion reception device.

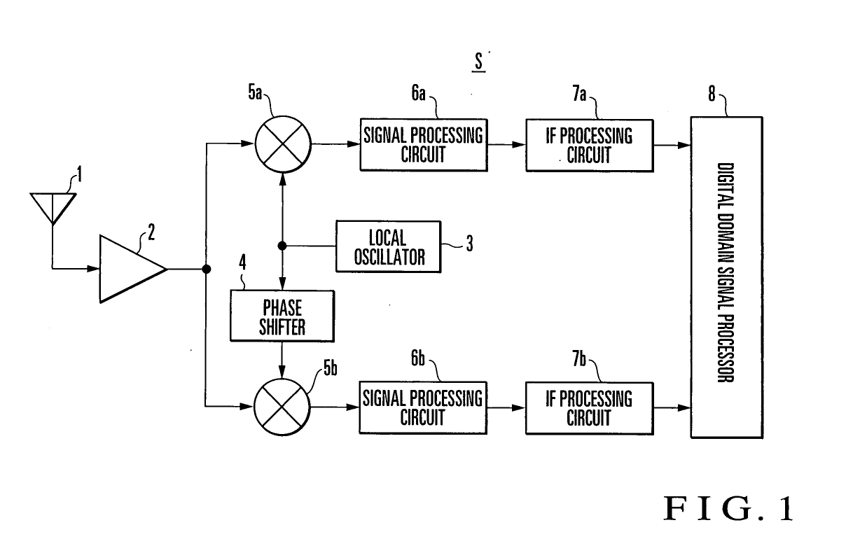

FIG. 1 is a view showing a schematic arrangement example of a direct conversion reception device according to this embodiment. As shown in FIG. 1, a direct conversion reception device S comprises an antenna 1 which receives an RF (Radio Frequency) signal as a high-frequency signal, an LNA (Low Noise Amplifier) 2 which amplifies an RF signal, a local oscillator 3 which generates a local signal as an oscillation signal (local oscillation signal), a phase shifter 4 which shifts the phase of a local signal by 90°, mixers 5a and 5b as mixing means for frequency-mixing amplified RF signals and local signals and converting (down-converting) the resultant signals into baseband signals, signal processing circuits 6a and 6b as signal processing units which perform predetermined processing for baseband signals, IF (Interface) processing circuits 7a and 7b including channel selection filters and ADCs (Analog to Digital Converters) which convert the processed baseband signals (I and Q components) into digital signals, and a digital domain signal processor 8 as a demodulation control unit which performs signal demodulation and the like on the basis of converted digital signals.

In this case, local signals input to the mixers 5a and 5b have a phase difference of 90° owing to the phase shifter 4, and the frequency of each signal is selected to be almost equal to the carrier frequency of a (desired) RF signal to be received. The digital domain signal processor 8 comprises a logical operation circuit (mainly comprising a CPU). The signal processing circuits 6a and 6b have functions of performing processing such as DC offset removal with respect to the baseband signals, obtained by down conversion using the mixers 5a and 5b, and regulating the DC potentials of signals. This makes it possible to meet both the requirement for processing of a dynamic DC offset and the requirement for signal transmission without any omission of a (desired) signal component to be received.

A plurality of embodiments of the signal processing device including the signal processing circuits 6a and 6b, the IF (Interface) processing circuits 7a and 7b, the digital domain signal processor 8, and the like will be described below. In the following embodiments, the signal processing circuits 6a and 6b will be mainly described. Since the signal processing circuits 6a and 6b have similar circuit arrangements, the signal processing circuit 6a will be representatively described below.

### FIRST EMBODIMENT

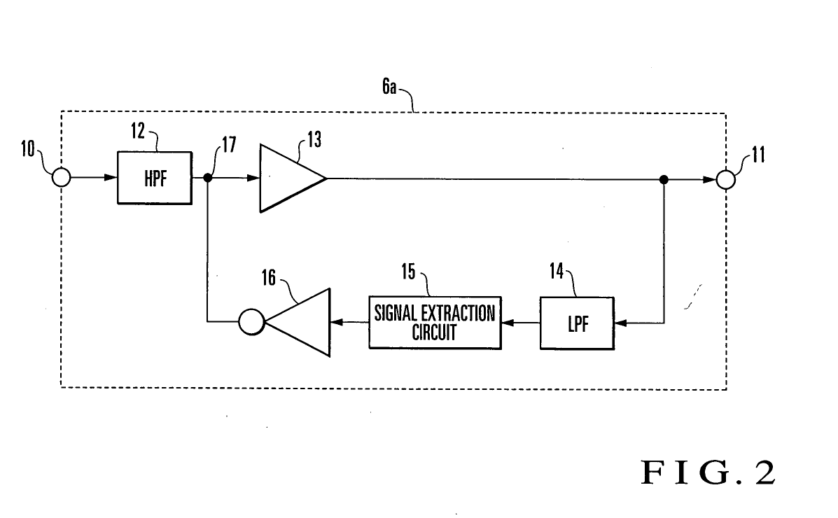

The arrangement and function of a signal processing device according to the first embodiment will be described first with reference to FIG. 2. FIG. 2 is a view showing a schematic arrangement example of a signal processing circuit 6a of the signal processing device according to the first embodiment.

The signal processing circuit 6a is designed to perform predetermined processing for a baseband signal input from an input unit 10 as an input unit and output the resultant signal from an output terminal 11 as an output unit. More specifically, as shown in FIG. 2, the signal processing circuit 6a in the first embodiment comprises a high-pass filter (HPF) 12 as a direct current component cutoff means (extraction means), an amplifier 13, a low-pass filter (LPF) 14 as a high-frequency component removal means, a signal extraction circuit 15 as a signal extraction means (extraction means), and an inverting amplifier 16 as an inverting means. The high-pass filter 12 and amplifier 13 are inserted in the output path extending from the input unit 10 to the output terminal 11, and the low-pass filter (LPF) 14, signal extraction circuit 15, and inverting amplifier 16 are inserted in the feedback path which feeds back from the output terminal 11 to the output node of the high-pass filter 12.

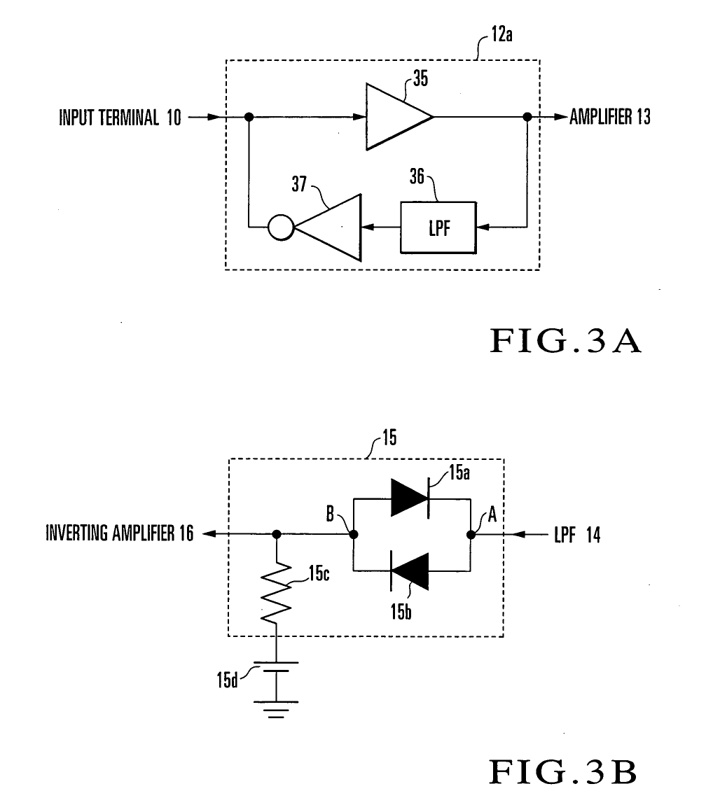

In the case shown in FIG. 2, inserting the inverting amplifier 16 in the above feedback path makes the path become a negative feedback path. A feedback point 17 at which a signal is fed back through the feedback path functions as a direct current potential regulation means (regulation means) in the present invention to regulate the direct current potential of a baseband signal passing through the high-pass filter 12. The high-pass filter 12 has a function of cutting off a direct current (to be referred to as “DC” hereinafter) component of an input baseband signal. The cutoff frequency of the high-pass filter 12 is selected to be low enough to neglect the influence of the omission of a (desired) signal component to be received. Note that a capacitor may be used in place of the high-pass filter 12. FIG. 3A is a view showing an example of the arrangement of an active filter, in which an active filter 12a comprising an amplifier 35, low-pass filter 36, and inverting amplifier 37 may be used in place of the high-pass filter 12.

Referring back to FIG. 2, the amplifier 13 has a function of amplifying a baseband signal from the feedback point 17. The amplifier 13 determines the gain of the DC potential regulation means in the present invention. A baseband signal output from the amplifier 13 is output from the output terminal 11 and input to the feedback path. Note that an attenuator or channel selection filter may be used in place of the amplifier 13. The low-pass filter 14 has a function of removing a high-frequency component of a baseband signal input to the feedback path from the amplifier 13. The cutoff frequency of the low-pass filter 14 is so selected as to extract a frequency component corresponding to a temporal variation in DC offset due to fading, the burst length of an interference wave, or the like. That is, the low-pass filter 14 functions to eliminate the influence of high-frequency components irrelevant to a DC offset.

The signal extraction circuit 15 has a function of extracting a signal corresponding to a voltage portion outside a predetermined voltage range if the voltage of a baseband signal from the low-pass filter 14 falls outside the voltage range. FIG. 3B is a view showing arrangement example 1 of the signal extraction circuit 15. FIG. 3C is a view showing the input voltage-current characteristic of the signal extraction circuit 15. As shown in FIG. 3B, the signal extraction circuit 15 is arranged such that diodes 15a and 15b are connected in anti-parallel, and one end of a load resistor 15c is connected to a node B. In addition, the node B is connected to the inverting amplifier 16, and a voltage source 15d for matching the input of the inverting amplifier 16 to the DC level is connected to the other end of the load resistor 15c. The above baseband signal is input from a node A in the signal extraction circuit 15.

“V0” shown in FIG. 3C is a DC voltage applied from the voltage source 15d, and “V1” is a turn-on voltage of the diodes 15a and 15b. That is, in the signal extraction circuit 15, an input current I becomes is almost 0 within the voltage range from “V0−V1” to “VO+V1”. In addition, an output voltage proportional to the input current I appears at the load resistor 15c. If, therefore, the voltage V of an input signal falls within the voltage range (predetermined voltage range) from “V0−V1” to “V0+V1”, the output voltage is the bias voltage of the voltage source 15d, i.e., “V0”. If the voltage V of the input signal falls outside this voltage range (exceeds the voltage range), only a voltage portion (excess) outside the voltage range is reflected in the output voltage. That is, a signal corresponding to the voltage portion outside the voltage range is extracted and output to the inverting amplifier 16. In other words, if the voltage of a baseband signal input to the signal extraction circuit 15 falls within a predetermined voltage range, the corresponding signal is not transferred to the output node (node B). If this voltage falls outside the voltage range, a signal of the corresponding signal which corresponds to the voltage portion outside the voltage range is transferred to the output node (node B). In this case, the voltage range from “V0−V1” to “V0+V1” is set such that the voltage of a baseband signal input to the signal extraction circuit 15 in a steady state falls within the voltage range. The case shown in FIG. 3B has exemplified the arrangement in which the two diodes 15a and 15b are connected in anti-parallel. However, the present invention is not limited to this.

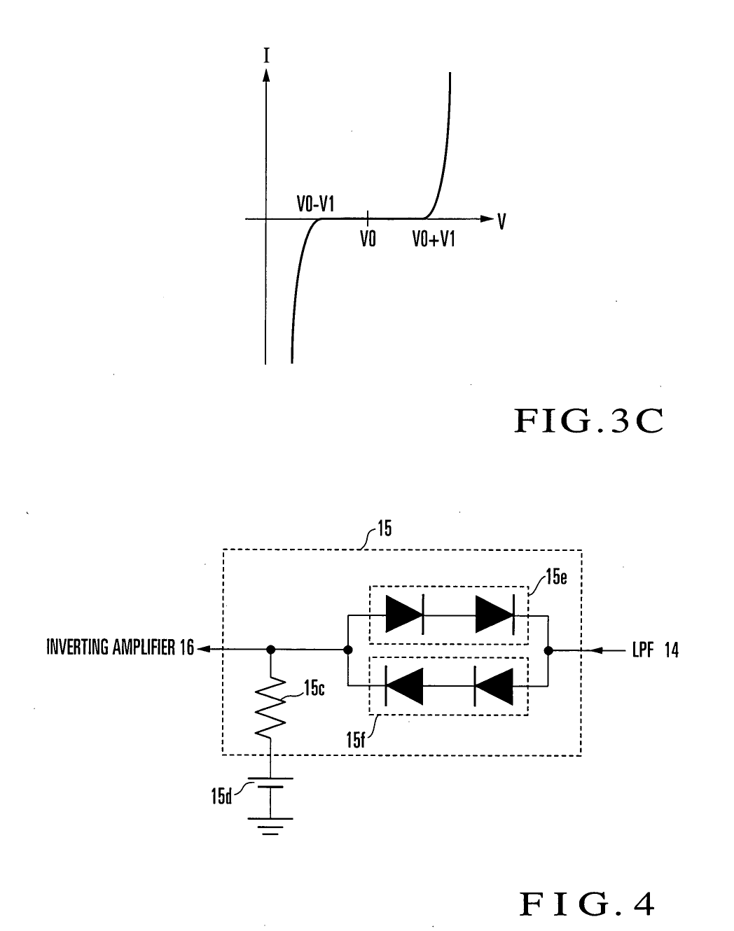

FIG. 4 is a view showing arrangement example 2 of the signal extraction circuit 15. In the example shown in FIG. 4, diode groups 15e and 15f each having two diodes connected in series are connected in anti-parallel. This example is the same as that shown in FIG. 3B except for this portion. In addition, the number of diodes to be connected in series may be three or more. Alternatively, a plurality of diode groups each having two diodes connected in anti-parallel may be connected in series instead of anti-parallel connection of the diode groups each having a plurality of diodes connected in series, or an in-between arrangement may be used. Each of the examples shown in FIGS. 3B and 4 may have an arrangement in which one of diodes or diode groups connected in anti-parallel may be omitted to use the forward ON voltage and reverse breakdown voltage of one diode. In addition, the signal extraction circuit 15 may be formed by using a bipolar transistor and field effect transistor (EFT) as well as being formed by using diodes.

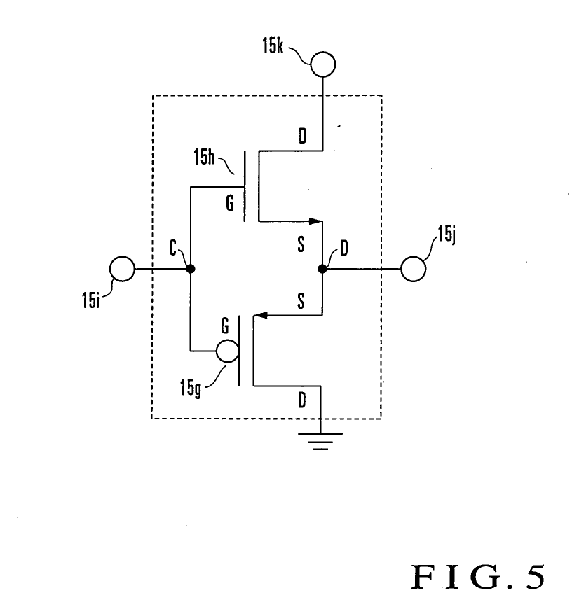

FIG. 5 is a view showing arrangement example 3 of the signal extraction circuit 15. The example in FIG. 5 shows only the core portion of the signal extraction circuit 15. This core portion comprises an N-type MOS (Metal Oxide Semiconductor) FET 15g and P-type MOSFET 15h, and is arranged such that a gate G of the N-type MOSFET 15g is connected to a gate G of the P-type MOSFET 15h, and a source S of the N-type MOSFET 15g is connected to a source S of the P-type MOSFET 15h. The N-type MOSFET 15g and P-type MOSFET 15h are connected such that each serves as a source follower. In addition, a node C between the gate G of the N-type MOSFET 15g and the gate G of the P-type MOSFET 15h is connected to an input terminal 15i to which the above baseband signal is input. A node D between the source S of the N-type MOSFET 15g and the source S of the P-type MOSFET 15h is connected to an output terminal 15j. Furthermore, a positive power supply voltage VDD is applied to a power supply terminal 15k, and a constant bias voltage VDD/2 is applied to the node D to extract an output as a current.

In this case, letting VTn be the threshold voltage of the N-type MOSFET 15g, and VTp (VTp<0) be the threshold voltage of the P-type MOSFET 15h, no amplifying operation is performed when an input voltage falls within the voltage range from “VDD/2+VTp” to “VDD/2+VTn” in the signal extraction circuit 15. If, therefore, the voltage of the input signal falls outside the voltage range, amplifying operation is performed to extract a signal corresponding to a voltage portion outside the voltage range and output it to the inverting amplifier 16. Note that as a circuit arrangement except for the core portion in the signal extraction circuit 15, any circuit arrangement can be employed as long as the above signal can be extracted.

Referring back to FIG. 2, the inverting amplifier 16 has a function of amplifying a signal extracted by the signal extraction circuit 15 upon inverting its polarity. The inverted signal is fed back to the output node of the high-pass filter 12. Note that the inverting amplifier 16 may be designed to be inserted between the amplifier 13 and the low-pass filter 14 or between the low-pass filter 14 and the signal extraction circuit 15. In addition, this circuit may be arranged such that the amplifier 13 is replaced by an inverting amplifier, and the inverting amplifier 16 is replaced by a non-inverting amplifier. Furthermore, the circuit may be arranged such that the amplifier 13 is replaced by an inverting amplifier, and the inverting amplifier 16 is omitted.

The operation of the signal processing device according to the first embodiment will be described next. The operation of this device in a steady state will be described first. In this case, a baseband signal input from the input unit 10 passes through the high-pass filter 12, is amplified by the amplifier 13, and is output from the output terminal 11. In the feedback path, since the voltage range of the signal extraction circuit 15 is set such that the voltage of a baseband signal from the low-pass filter 14 in a steady state falls within the voltage range, no signal is extracted. Therefore, no signal is negatively fed back to the output node of the high-pass filter 12.

Operation to be performed when a DC offset amount varies stepwise at a given time will be described next. As described above, the cutoff frequency of the high-pass filter 12 is selected to be sufficiently low. In this case, therefore, a DC voltage step produced by a DC offset variation contained in an input baseband signal passes through the high-pass filter 12 and hence without almost being changed, and is input to the amplifier 13 to be amplified. The baseband signal containing the DC voltage step is input to the low-pass filter 14 in the feedback path, in which a low-frequency component is extracted. This component is input to the signal extraction circuit 15. The signal extraction circuit 15 extracts a signal component, of the input baseband signal component, which corresponds to a portion outside the above voltage range (a peak-to-peak component exceeding 2×V1 in the example shown in FIG. 3B) as an unneglectable temporal variation in the DC offset. The extracted component is output (transmitted) to the inverting amplifier 16.

The extracted signal is inverted/amplified by the inverting amplifier 16 and is fed back to the output node of the high-pass filter 12. With this operation, the output node of the high-pass filter 12 is immediately charged, and its potential changes in a direction reverse to a step variation in DC offset. At the feedback point 17 shown in FIG. 2, the signal component extracted from the baseband signal passing through the high-pass filter 12 by the signal extraction circuit 15 is canceled out, and the DC potential of the baseband signal is regulated. This operation continues until the voltage of the baseband signal input to the signal extraction circuit 15 falls within the above voltage range (in which no signal is extracted). When the above operation is complete, the voltage of the baseband signal keeps falling in the range in which signal extracting (transmitting) operation is stopped. That is, a steady state continues. This indicates that with respect to a transfer function from the output node of the high-pass filter 12 to the output terminal 11 in a state wherein the voltage of the baseband signal input to the feedback circuit falls outside the predetermined voltage range, the corresponding low-frequency cutoff is higher than the low-frequency cutoff of the high-pass filter 12.

The signal processed by the signal processing circuit 6a and output from the output terminal 11 in this manner is converted into a digital signal by the IF processing circuit 7a (similar operation is performed on the signal processing circuit 6b side), and is demodulated by a digital domain signal processor 8.

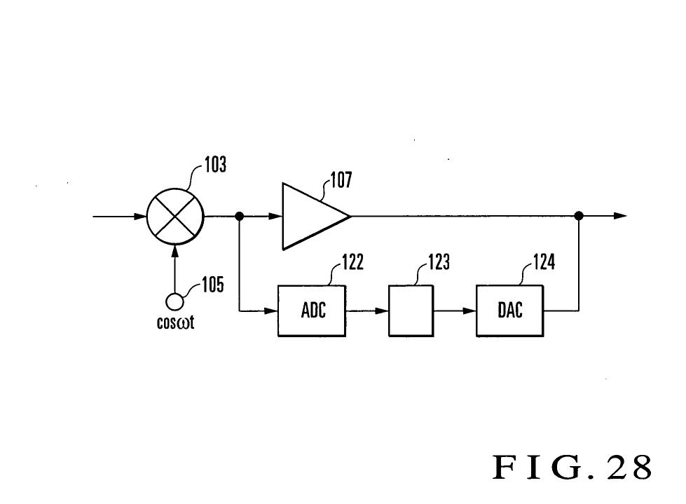

As described above, the first embodiment described above can meet both the requirement for transmission without any omission of a desired signal component and the requirement for processing for a dynamic offset, which cannot be met by the conventional technique using the element with the simple high-pass characteristic. In addition, the first embodiment described above does not require any complicated ADC and DAC, need not externally supply a control signal synchronized with a time slot, and can handle a variation in DC offset in a desired reception time slot, unlike the conventional technique shown in FIG. 28.

The first embodiment is designed to directly monitor a variation in DC offset and perform canceling operation for the offset instead of indirectly observing and controlling a variation in DC offset in the form of a variation in reception signal level as in the technique disclosed in patent reference 1. Therefore, the first embodiment is superior in terms of the reliability of operation. That is, even if the reception signal level does not vary, the mechanism for the convergence of the output DC level reliably operates as long as the DC offset varies, and does not perform unnecessary operation such as omitting a desired signal component unless the DC offset varies even if the reception signal level varies. In addition, this embodiment requires no control device which generates control signals to the high-pass filter upon determining a variation in reception signal level, and hence is advantageous in that its arrangement is simple.

In addition, according to the first embodiment, the input node and output node are separated in terms of DC by the high-pass filter 12. This solves the problem in the technique disclosed in patent reference 2 that convergence of an output DC level and an increase in time constant cannot be achieved at the same time. That is, according to the first embodiment, if charging of the output node of the high-pass filter 12 is complete, a steady state is reliably restored, in which the signal extraction circuit 15 extracts (transmits) no signal.

Note that in the first embodiment, even with the signal processing circuit 6a from which the low-pass filter 14 is omitted, the same effects as those of the first embodiment can be obtained depending on the state of the high-frequency component level of an output from the amplifier 13 or a relationship with the time constant of a DC offset assumed to be the frequency characteristic of the amplifier 13.

The signal processing device according to the first embodiment described above exemplifies an example of the present invention. Other embodiments will be described below. Note that the same reference numerals as in the first embodiment (or the fifth embodiment) denote the same components in signal processing devices according to the following embodiments (second to 19th embodiments), and a repetitive description thereof will be omitted. As in the first embodiment, in each of the following embodiments (second to 19th embodiments), the low-pass filter 14 may be omitted, and the signal extraction circuit 15 has the same arrangement as that in the first embodiment (for example, any of the arrangements shown in FIGS. 3B, 4, and 5).

### SECOND EMBODIMENT

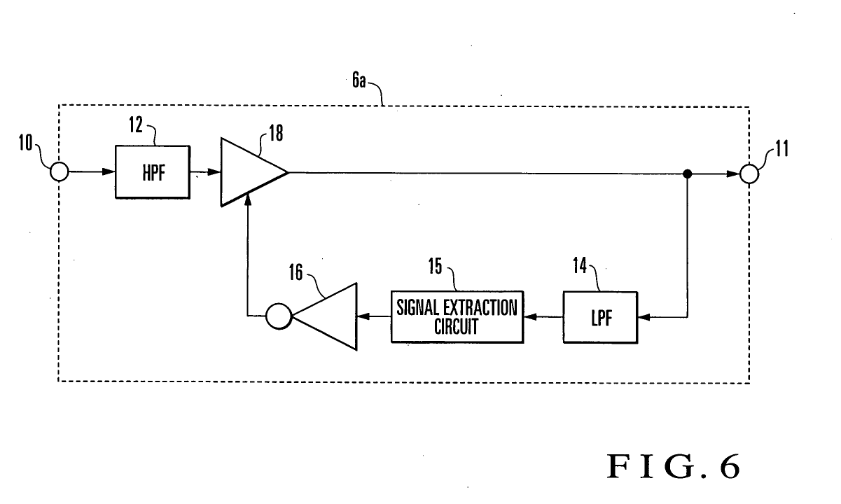

A signal processing device according to the second embodiment will be described first with reference to FIG. 6. FIG. 6 is a view showing a schematic arrangement example of a signal processing circuit 6a of the signal processing device according to the second embodiment. As shown in FIG. 6, the signal processing circuit 6a in the second embodiment differs from the signal processing circuit 6a in the first embodiment in that the amplifier 13 is replaced by an amplifier 18. The amplifier 18 includes an regulation terminal which regulates the DC level of an output voltage, in addition to an input terminal and output terminal, and functions as a direct current potential regulation means of the present invention. The amplifier 18 regulates the direct current potential of a baseband signal passing through a high-pass filter 12. In addition, the amplifier 18 determines the gain of the direct current potential regulation means of the present invention.

In this arrangement, a feedback signal (a signal extracted by a signal extraction circuit 15 and inverted/amplified by an inverting amplifier 16) output from the inverting amplifier 16 is input to the regulation terminal of the amplifier 18. With this operation, in the amplifier 18, the signal component extracted from the baseband signal passing through the high-pass filter 12 by the signal extraction circuit 15 is canceled out, thereby regulating the direct current voltage of the baseband signal. Like the first embodiment, therefore, the second embodiment is free from the influence of a step variation in DC offset, and can obtain the same effects as those of the first embodiment. Note that the inverting amplifier 16 needs to be replaced by a non-inverting amplifier or an inverting amplifier needs to be inserted between the amplifier 18 and the entrance of a feedback path depending on a control signal to be supplied to the control terminal of the amplifier 18 and the correlation sign of the DC level of an output voltage.

### THIRD EMBODIMENT

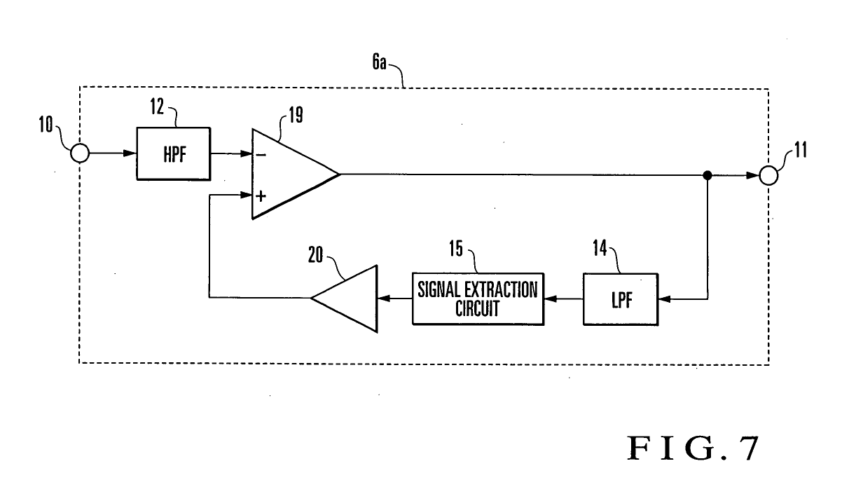

A signal processing device according to the third embodiment will be described next with reference to FIG. 7. FIG. 7 is a view showing a schematic arrangement example of a signal processing circuit 6a of the signal processing device according to the third embodiment. As shown in FIG. 7, the signal processing circuit 6a in the third embodiment differs from the signal processing circuit 6a in the first embodiment in that the inverting amplifier 16 is replaced by a non-inverting amplifier 20, and the amplifier 13 is replaced by a differential amplifier 19. The differential amplifier 19 includes an inverting input terminal, non-inverting input terminal, and output terminal, and functions as a direct current potential regulation means of the present invention. The differential amplifier 19 regulates the direct current potential of a baseband signal passing through a high-pass filter 12. In addition, the differential amplifier 19 determines the gain of the direct current potential regulation means of the present invention.

In this arrangement, a baseband signal passing through the high-pass filter 12 is input to the inverting input terminal of the differential amplifier 19, and a feedback signal extracted by the signal extraction circuit 15 and amplified by the non-inverting amplifier 20 is input to the non-inverting input terminal of the differential amplifier 19. The differential amplifier 19 obtains the difference between the two input signals and outputs it. With this operation, in the differential amplifier 19, the signal component extracted from the baseband signal passing through the high-pass filter 12 by the signal extraction circuit 15 is canceled out, thereby regulating the direct current voltage of the baseband signal. Like the first embodiment, therefore, the third embodiment is free from the influence of a step variation in DC offset, and can obtain the same effects as those of the first embodiment.

### FOURTH EMBODIMENT

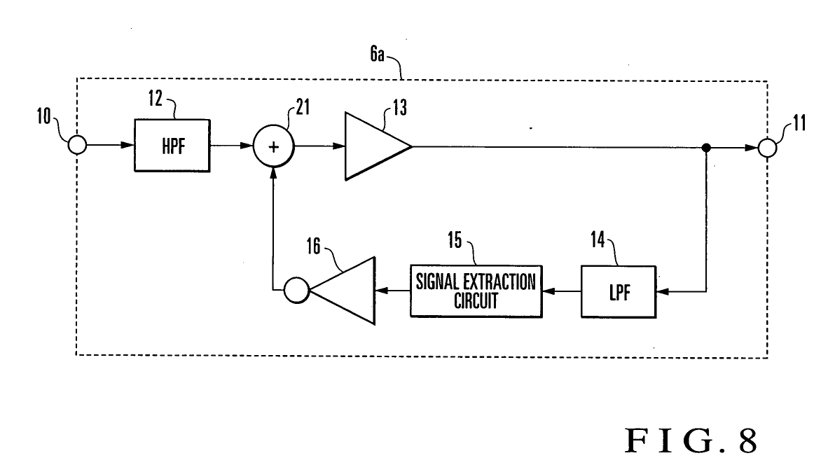

A signal processing device according to the fourth embodiment will be described next with reference to FIG. 8. FIG. 8 is a view showing a schematic arrangement example of a signal processing circuit 6a of the signal processing device according to the fourth embodiment. As shown in FIG. 8, the signal processing circuit 6a in the fourth embodiment differs from the signal processing circuit 6a in the first embodiment in that an adder 21 is provided at the feedback point 17 shown in FIG. 2. The adder 21 functions as a direct current potential regulation means of the present invention, and regulates the direct current potential of a baseband signal passing through a high-pass filter 12.

In this arrangement, the adder 21 adds a baseband signal passing through the high-pass filter 12 and a feedback signal (a signal extracted by the signal extraction circuit 15 and inverted/amplified by an inverting amplifier 16) output from the inverting amplifier 16 and outputs the resultant signal. With this operation, in the adder 21, the signal component extracted from the baseband signal passing through the high-pass filter 12 by a signal extraction circuit 15 is canceled out, thereby regulating the direct current potential of the baseband signal. Like the first embodiment, therefore, the fourth embodiment is free from the influence of a step variation in DC offset, and can obtain the same effects as those of the first embodiment.

### FIFTH EMBODIMENT

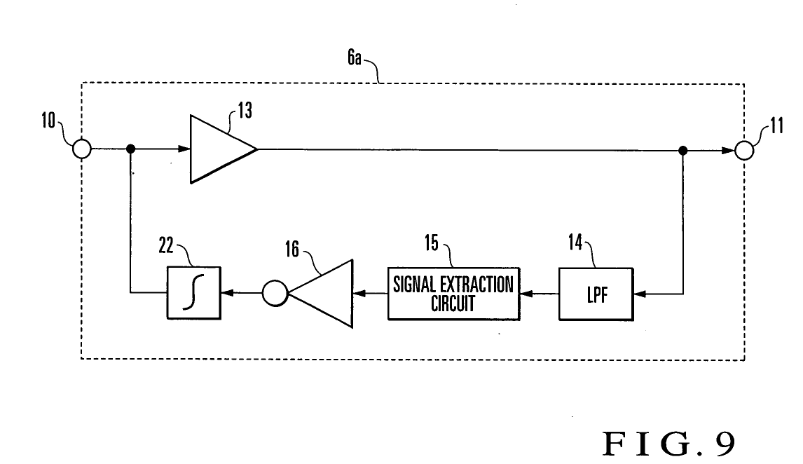

A signal processing device according to the fifth embodiment will be described next with reference to FIG. 9. FIG. 9 is a view showing a schematic arrangement example of a signal processing circuit 6a of the signal processing device according to the fifth embodiment. As shown in FIG. 9, the signal processing circuit 6a in the fifth embodiment differs from the signal processing circuit 6a in the first embodiment in that the high-pass filter 12 as the direct current component cutoff means is omitted, and an integrator 22 as an integration means (regulation means) is provided at the exit of a feedback path.

In this arrangement, if a DC offset amount varies stepwise at a given time, a baseband signal input from an input unit 10 is amplified by an amplifier 13, and a low-frequency component is extracted from the baseband signal by a low-pass filter 14 in the feedback path. The resultant signal is input to a signal extraction circuit 15 as a signal extraction means (extraction means). Subsequently, the signal extraction circuit 15 extracts a signal component, of the input baseband signal component, which corresponds to a portion outside the above voltage range as an unneglectable temporal variation in the DC offset. The extracted component is output (transmitted) to an inverting amplifier 16. The extracted signal is then inverted/amplified by the inverting amplifier 16 and output to the integrator 22. This signal is integrated by the integrator 22 to update the DC offset correction amount at the input of the amplifier 13. This updating of the DC offset correction amount continues until the residual DC offset amount is sufficiently reduced, and the voltage of the baseband signal input to the signal extraction circuit 15 falls within the above voltage range (in which no signal is extracted). Like the first embodiment, therefore, the fifth embodiment is free from the influence of a step variation in DC offset, and can obtain the same effects as those of the first embodiment. In the fifth embodiment, the integrator 22 is provided at the exit of the feedback path. However, the present invention is not limited to this, and the integrator 22 may be inserted between the signal extraction circuit 15 and the inverting amplifier 16.

### SIXTH EMBODIMENT

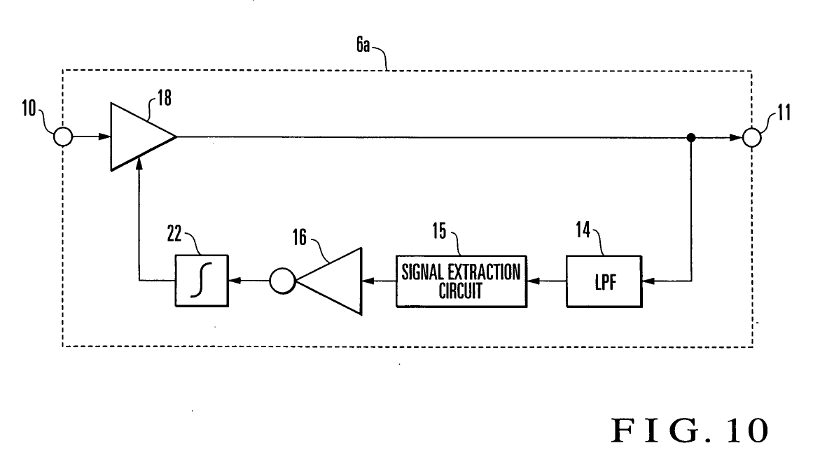

A signal processing device according to the sixth embodiment will be described next with reference to FIG. 10. FIG. 10 is a view showing a schematic arrangement example of a signal processing circuit 6a of the signal processing device according to the sixth embodiment. As shown in FIG. 10, the signal processing circuit 6a in the sixth embodiment differs from the signal processing circuit 6a in the fifth embodiment in that the amplifier 13 is replaced by an amplifier 18. The amplifier 18 has the same function as that of the amplifier 18 in the second embodiment.

In this arrangement, a feedback signal (a signal extracted by the signal extraction circuit 15, inverted/amplified by an inverting amplifier 16, and integrated by an integrator 22) output from the integrator 22 is input to the regulation terminal of the amplifier 18. With this operation, in the amplifier 18, the signal component extracted from the input baseband signal by a signal extraction circuit 15 and integrated is canceled out, thereby regulating the direct current potential of the baseband signal. Like the first embodiment, therefore, the sixth embodiment is free from the influence of a step variation in DC offset, and can obtain the same effects as those of the first embodiment. Note that as in the fifth embodiment, in the sixth embodiment, the integrator 22 may be inserted between, for example, the signal extraction circuit 15 and the inverting amplifier 16.

### SEVENTH EMBODIMENT

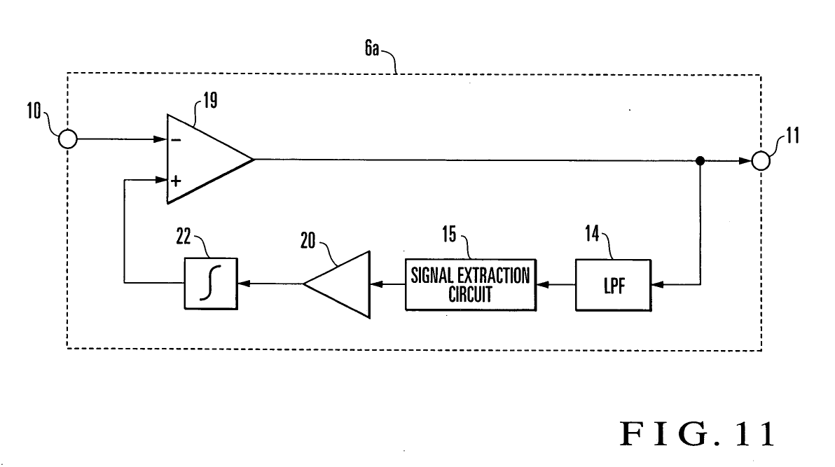

A signal processing device according to the seventh embodiment will be described next with reference to FIG. 11. FIG. 11 is a view showing a schematic arrangement example of a signal processing circuit 6a of the signal processing device according to the seventh embodiment. As shown in FIG. 11, the signal processing circuit 6a in the seventh embodiment differs from the signal processing circuit 6a in the fifth embodiment in that the inverting amplifier 16 is replaced by a non-inverting amplifier 20, and the amplifier 13 is replaced by a differential amplifier 19. The differential amplifier 19 has the same function as that of the differential amplifier 19 in the third embodiment.

In this arrangement, an input baseband signal is input to the inverting input terminal of the differential amplifier 19, and a feedback signal (a signal extracted by a signal extraction circuit 15, inverted/amplified by the inverting amplifier 16, and integrated by an integrator 22) output from the integrator 22 is input to the non-inverting input terminal of the differential amplifier 19. The differential amplifier 19 then obtains the difference between the two input signals and outputs it. With this operation, in the differential amplifier 19, the signal component extracted from the input baseband signal by the signal extraction circuit 15 and integrated is canceled out, thereby regulating the direct current potential of the baseband signal. Like the first embodiment, therefore, the seventh embodiment is free from the influence of a step variation in DC offset, and can obtain the same effects as those of the first embodiment. Note that as in the fifth embodiment, in the seventh embodiment, the integrator 22 may be inserted between, for example, the signal extraction circuit 15 and the amplifier 20.

### EIGHTH EMBODIMENT

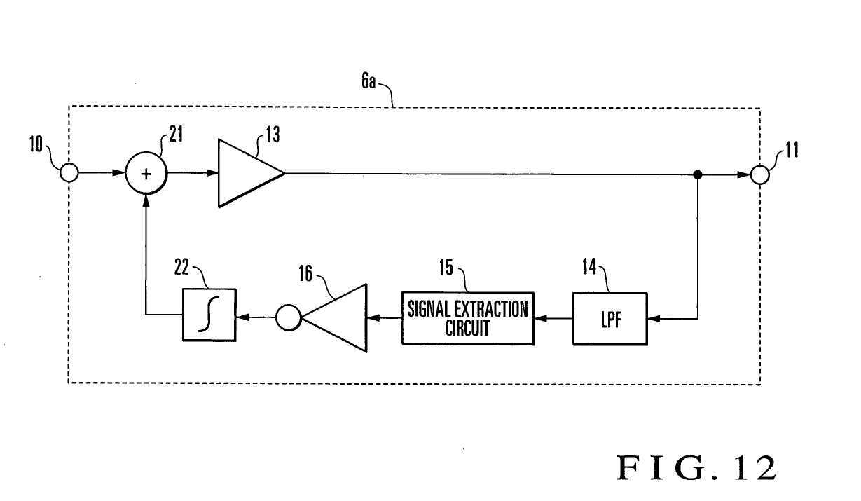

A signal processing device according to the eighth embodiment will be described next with reference to FIG. 12. FIG. 12 is a view showing a schematic arrangement example of a signal processing circuit 6a of the signal processing device according to the eighth embodiment. As shown in FIG. 12, the signal processing circuit 6a in the eighth embodiment differs from the signal processing circuit 6a in the fifth embodiment in that an adder 21 is provided at the feedback point 17 shown in FIG. 2. The adder 21 has the same function as that of the adder 21 in the fourth embodiment.

In this arrangement, the adder 21 adds an input baseband signal and a feedback signal (a signal extracted by the signal extraction circuit 15, inverted/amplified by the inverting amplifier 16, and integrated by an integrator 22) output from the integrator 22 and outputs the resultant signal. With this operation, the signal component extracted from the input baseband signal by the signal extraction circuit 15 and integrated is canceled out to regulate the direct current potential of the baseband signal. Like the first embodiment, therefore, the eighth embodiment is free from the influence of a step variation in DC offset, and can obtain the same effects as those of the first embodiment. Note that as in the fifth embodiment, in the eighth embodiment, the integrator 22 may be inserted between a signal extraction circuit 15 and an inverting amplifier 16.

### NINTH EMBODIMENT

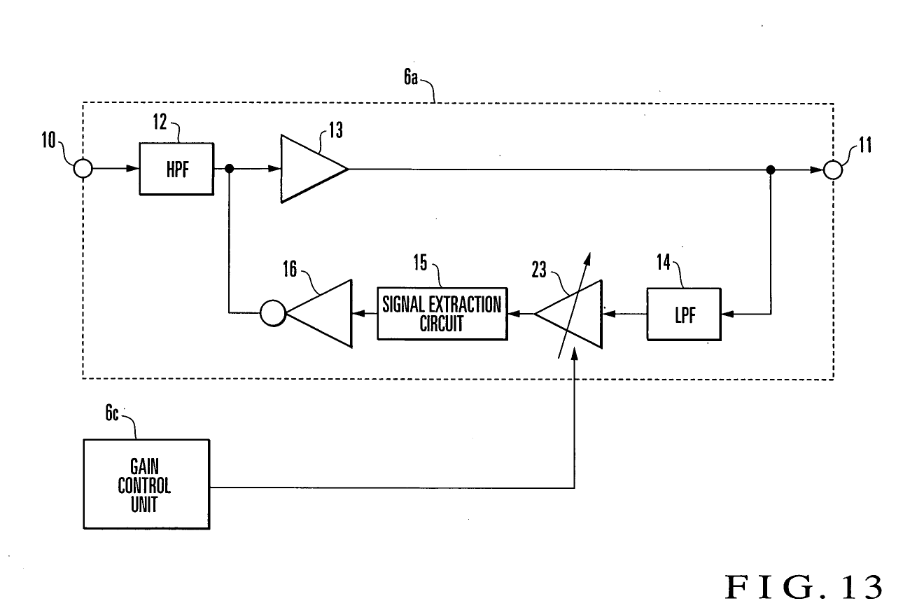

A signal processing device according to the ninth embodiment will be described next with reference to FIG. 13. FIG. 13 is a view showing a schematic arrangement example of a signal processing circuit 6a and the like of the signal processing device according to the ninth embodiment. As shown in FIG. 13, the signal processing circuit 6a in the ninth embodiment differs from the signal processing circuit 6a in the first embodiment in that a variable gain amplifier 23 as a third variable gain means is inserted between a low-pass filter 14 and a signal extraction circuit 15. In addition, in the ninth embodiment, the signal processing device is provided with a gain control unit 6c which performs gain control on the variable gain amplifier 23. The gain control unit 6c comprises, for example, a logical operation circuit, and is designed to calculate a gain and supply a control signal to the variable gain amplifier 23 in accordance with the gain. The variable gain amplifier 23 can change the gain in accordance with a control signal from the gain control unit 6c.

According to the arrangement of the ninth embodiment, the same effects as those of the first embodiment can be obtained. In addition, even if the amplitude of a desired signal component contained in an input baseband signal changes, adjusting the gain of the variable gain amplifier 23 makes it possible to prevent the input amplitude of the signal extraction circuit 15 in a steady state from excessively decreasing or increasing. Note that each of the signal processing circuits 6a in the second to eighth embodiments may be arranged such that the variable gain amplifier 23 is inserted between the low-pass filter 14 and the signal extraction circuit 15. This makes it possible to obtain the same effects as those of the ninth embodiment.

### 10TH EMBODIMENT

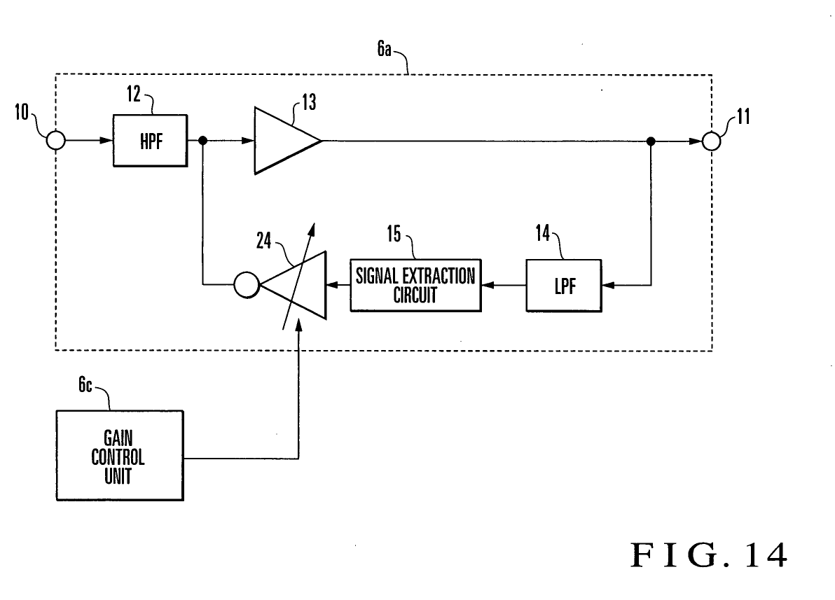

A signal processing device according to the 10th embodiment will be described next with reference to FIG. 14. FIG. 14 is a view showing a schematic arrangement example of a signal processing circuit 6a and the like of the signal processing device according to the 10th embodiment. As shown FIG. 14, the signal processing circuit 6a in the 10th embodiment differs from the signal processing circuit 6a in the first embodiment in that the inverting amplifier 16 is replaced by a variable gain inverting amplifier 24 as a second variable gain means. In addition, in the 10th embodiment, the signal processing device is provided with a gain control unit 6c which controls the gain of the variable gain inverting amplifier 24. The gain control unit 6c calculates a gain, and supplies a control signal corresponding to the calculated gain to the variable gain inverting amplifier 24. The variable gain inverting amplifier 24 can change the gain in accordance with a control signal from the gain control unit 6c.

The 10th embodiment can adjust the follow-up response speed with respect to a DC offset variation and the behavior of overshoot at the time of follow-up operation as well as being able to obtain the same effects as those of the first embodiment. Note that in each of the signal processing circuits 6a according to the second to eighth embodiments as well, the variable gain inverting amplifier 24 (or a variable gain amplifier) may be used in place of the inverting amplifier 16 (or the amplifier 20). This can also obtain the same effects as those of the 10th embodiment.

### 11TH EMBODIMENT

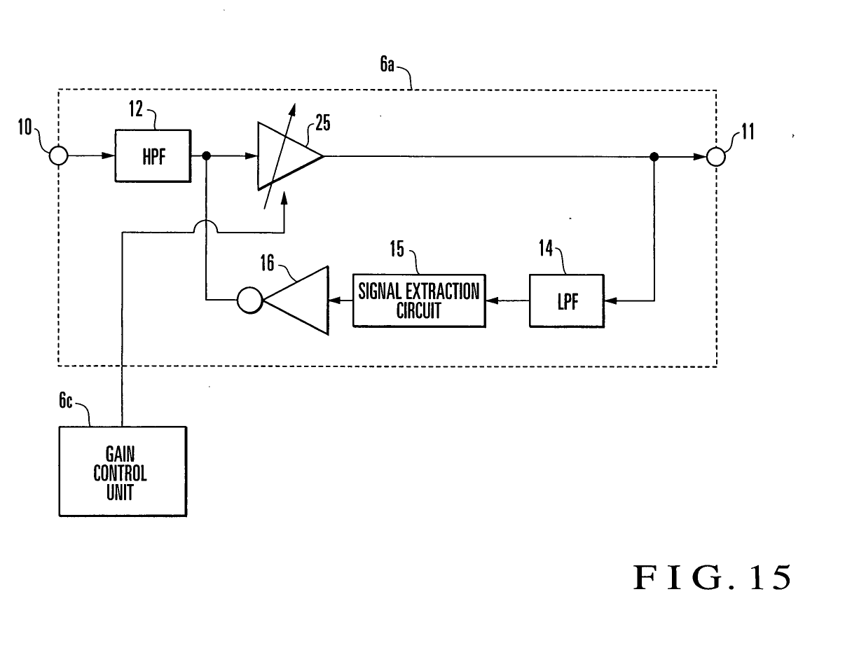

A signal processing device according to the 11th embodiment will be described next with reference to FIG. 15. FIG. 15 is a view showing a schematic arrangement example of a signal processing circuit 6a and the like of the signal processing device according to the 11th embodiment. As shown in FIG. 15, the signal processing circuit 6a in the 11th embodiment differs from the signal processing circuit 6a in the first embodiment in that the amplifier 13 is replaced by a variable gain amplifier 25 as a first variable gain means. In addition, in the 11th embodiment, the signal processing device is provided with a gain control unit 6c which controls the gain of the variable gain amplifier 25. The gain control unit 6c calculates a gain, and supplies a control signal corresponding to the calculated gain to the variable gain amplifier 25. The variable gain amplifier 25 can change the gain in accordance with a control signal from the gain control unit 6c.

The 11th embodiment can make the overall circuit have the function of a variable gain amplifier as well as being able to obtain the same effects as those of the first embodiment. In each of the signal processing circuits 6a according to the second to eighth embodiments as well, the variable gain amplifier 25 may be used in place of the amplifier 13. This makes it possible to obtain the same effects as those of the 11th embodiment.

### 12TH EMBODIMENT

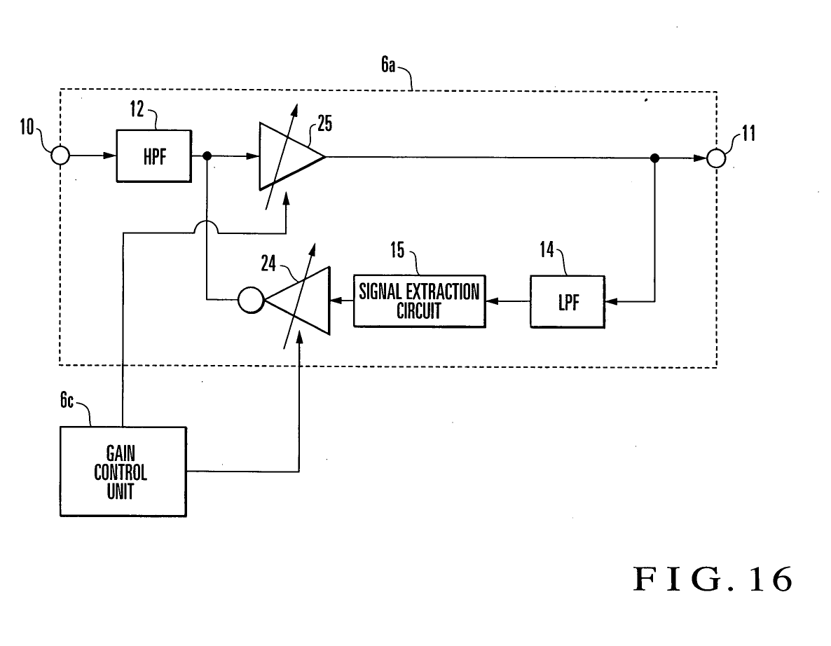

A signal processing device according to the 12th embodiment will be described next with reference to FIG. 16. FIG. 16 is a view showing a schematic arrangement example of a signal processing circuit 6a and the like of the signal processing device according to the 12th embodiment. As shown in FIG. 16, a signal processing circuit 6a in the 12th embodiment differs from the signal processing circuit 6a in the first embodiment in that the amplifier 13 is replaced by a variable gain amplifier 25, and the inverting amplifier 16 is replaced by a variable gain inverting amplifier 24. In addition, according to the 12th embodiment, the signal processing device includes a gain control unit 6c which controls the gains of the variable gain inverting amplifier 24 and variable gain amplifier 25. The gain control unit 6c is, for example, designed to calculate gains and supply control signals corresponding to the gains to the variable gain inverting amplifier 24 and variable gain amplifier 25. The variable gain inverting amplifier 24 and variable gain amplifier 25 can change their gains in accordance with control signals from the gain control unit 6c.

The 12th embodiment can make the overall circuit have the function of a variable gain amplifier and adjust the follow-up response speed with respect to a DC offset variation and the behavior of overshoot at the time of follow-up operation by changing the gain of the variable gain inverting amplifier 24 as well as being able to obtain the same effects as those of the first embodiment. Note that the gain control unit 6c may control the gains of the variable gain inverting amplifier 24 and variable gain amplifier 25 so as to make them have a correlation, or may control the gains independently. As an example of control by making the gains have a correlation, a method of keeping the product of the gains of the variable gain inverting amplifier 24 and variable gain amplifier 25 constant is available.

In each of the signal processing circuits 6a according to the second to eighth embodiments, the variable gain amplifier 25 may be used in place of the amplifier 13, and the variable gain inverting amplifier 24 (or a variable gain amplifier) 24 may be used in place of the inverting amplifier 16 (or the amplifier 20). This makes it possible to obtain the same effects as those of the 12th embodiment.

### 13TH EMBODIMENT

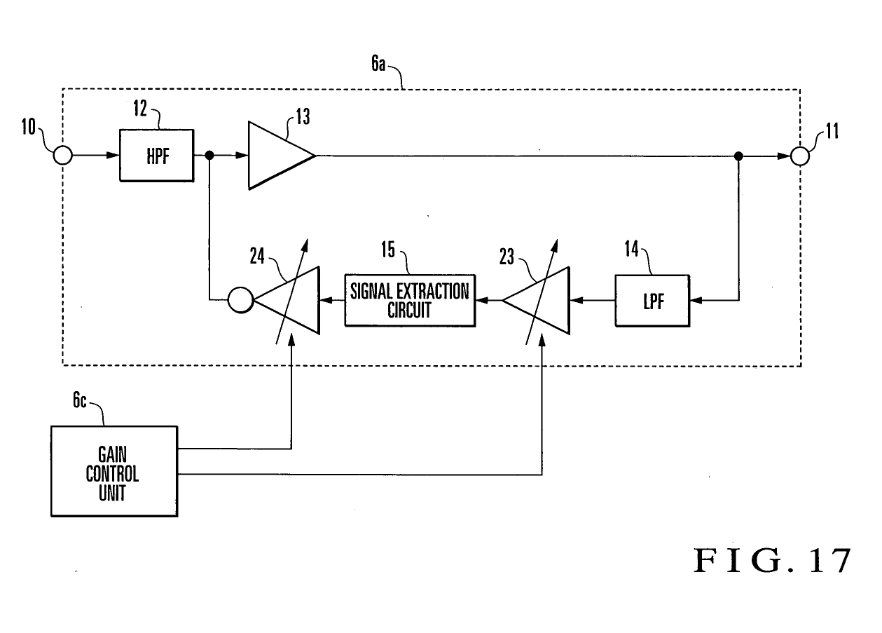

A signal processing device according to the 13th embodiment will be described next with reference to FIG. 17. FIG. 17 is a view showing a schematic arrangement example of a signal processing circuit 6a and the like of the signal processing device according to the 13th embodiment. As shown in FIG. 17, the signal processing circuit 6a in the 13th embodiment differs from the signal processing circuit 6a in the first embodiment in that a variable gain amplifier 23 is inserted between a low-pass filter 14 and a signal extraction circuit 15, and the inverting amplifier 16 is replaced by a variable gain inverting amplifier 24. In addition, in the 13th embodiment, the signal processing device includes a gain control unit 6c which controls the gains of the variable gain amplifier 23 and variable gain inverting amplifier 24. The gain control unit 6c is designed to calculate gains and supply control signals corresponding to the gains to the variable gain amplifier 23 and variable gain inverting amplifier 24. The variable gain amplifier 23 and variable gain inverting amplifier 24 can change their gains in accordance with control signals from the gain control unit 6c.

The 13th embodiment can prevent an input amplitude to the signal extraction circuit 15 in a steady state from excessively decreasing or increasing, even if the amplitude of a desired signal component contained in the input baseband signal changes, by adjusting the gain of the variable gain amplifier 23, as well as being able to obtain the same effects as those of the first embodiment. In addition, the 13th embodiment can adjust the follow-up response speed with respect to a DC offset variation and the behavior of overshoot at the time of follow-up operation by changing the gain of the variable gain inverting amplifier 24.

Note that the gain control unit 6c may control the gains of the variable gain amplifier 23 and variable gain inverting amplifier 24 so as to make them have a correlation, or may control the gains independently. As an example of control by making the gains have a correlation, a method of keeping the product of the gains of the variable gain amplifier 23 and variable gain inverting amplifier 24 constant is available. This method can substantially change the threshold for signal extraction (transmission)/non-extraction (non-transmission) in the signal extraction circuit 15 while keeping the follow-up response speed with respect to a DC offset variation and the behavior of overshoot at the time of follow-up operation constant. In each of the signal processing devices according to the second to eighth embodiments, the variable gain amplifier 23 may be inserted between the low-pass filter 14 and the signal extraction circuit 15, and the variable gain inverting amplifier 24 (or a variable gain amplifier) may be used in place of the inverting amplifier 16 (or the amplifier 20). This makes it possible to obtain the same effects as those of the 13th embodiment.

### 14TH EMBODIMENT

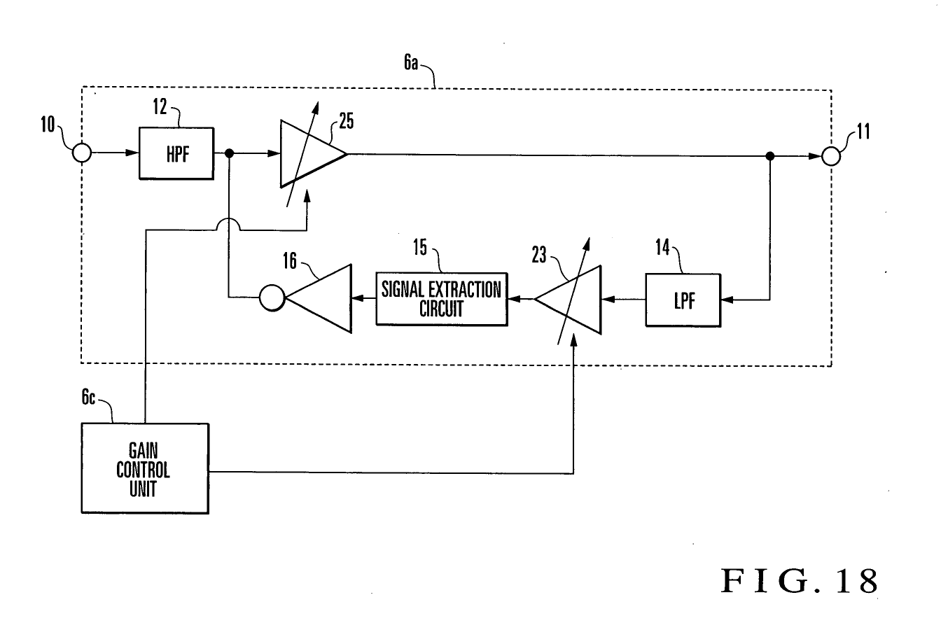

A signal processing device according to the 14th embodiment will be described next with reference to FIG. 18. FIG. 18 is a view showing a schematic arrangement example of a signal processing circuit 6a and the like of the signal processing device according to the 14th embodiment. As shown in FIG. 18, the signal processing circuit 6a in the 14th embodiment differs from the signal processing circuit 6a in the first embodiment in that a variable gain amplifier 23 is inserted between a low-pass filter 14 and a signal extraction circuit 15, and the amplifier 13 is replaced by a variable gain amplifier 25. In addition, in the 14th embodiment, the signal processing device includes a gain control unit 6c which controls the gains of the variable gain amplifier 23 and variable gain amplifier 25. The gain control unit 6c is designed to calculate gains and supply control signals corresponding to the gains to the variable gain amplifier 23 and variable gain amplifier 25. The variable gain amplifier 23 and variable gain amplifier 25 can change their gains in accordance with control signals from the gain control unit 6c.

The 14th embodiment can prevent an input amplitude to the signal extraction circuit 15 in a steady state from excessively decreasing or increasing, even if the amplitude of a desired signal component contained in the input baseband signal changes, by adjusting the gain of the variable gain amplifier 23, as well as being able to obtain the same effects as those of the first embodiment. In addition, the 14th embodiment can make the overall circuit have the function of a variable gain amplifier.

Note that the gain control unit 6c may control the gains of the variable gain amplifier 23 and variable gain amplifier 25 so as to make them have a correlation, or may control the gains independently. As an example of control with a correlation, a method of keeping the product of the gains of the variable gain amplifier 23 and variable gain amplifier 25 constant is available. This method can make the overall circuit have the function of a variable gain amplifier while keeping the follow-up response speed with respect to a DC offset variation and the behavior of overshoot at the time of follow-up operation constant. In each of the signal processing circuits 6a according to the second to eighth embodiments, the variable gain amplifier 23 may be inserted between the low-pass filter 14 and the signal extraction circuit 15, and the variable gain amplifier 25 may be used in place of the amplifier 13. This makes it possible to obtain the same effects as those of the 14th embodiment.

### 15TH EMBODIMENT

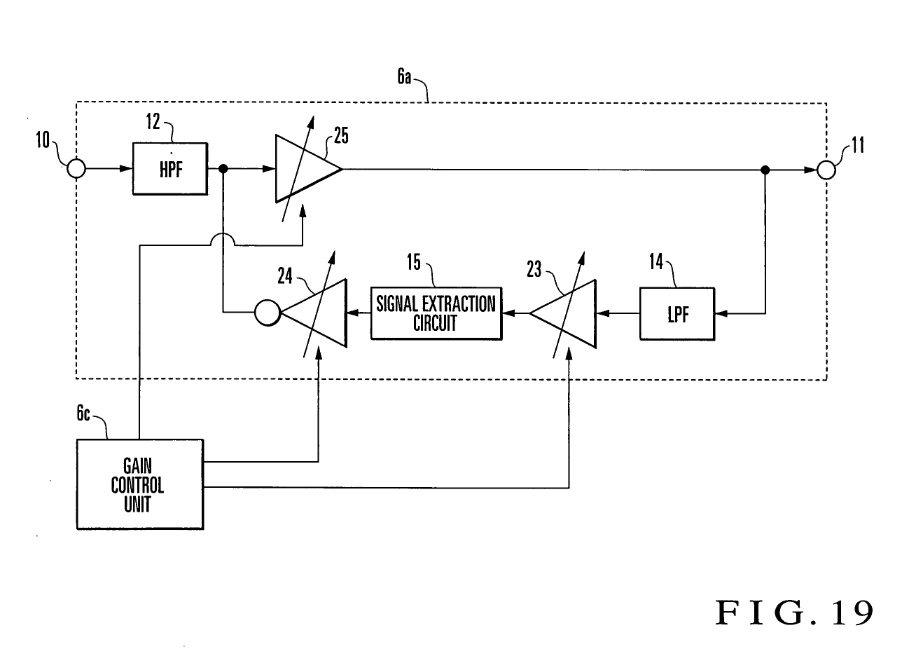

A signal processing device according to the 15th embodiment will be described next with reference to FIG. 19. FIG. 19 is a view showing a schematic arrangement example of a signal processing circuit 6a and the like of the signal processing device according to the 15th embodiment. As shown in FIG. 19, the signal processing circuit 6a in the 15th embodiment differs from the signal processing circuit 6a in the first embodiment in that a variable gain amplifier 23 is inserted between a low-pass filter 14 and a signal extraction circuit 15, the inverting amplifier 16 is replaced by a variable gain inverting amplifier 24, and the amplifier 13 is replaced by a variable gain amplifier 25. In addition, according to the 14th embodiment, the signal processing device includes a gain control unit 6c which controls the gains of the variable gain amplifier 23, variable gain inverting amplifier 24, and variable gain amplifier 25. The gain control unit 6c is designed to calculate gains and supply control signals corresponding to the gains to the variable gain amplifier 23, variable gain inverting amplifier 24, and variable gain amplifier 25. The variable gain amplifier 23, variable gain inverting amplifier 24, and variable gain amplifier 25 can change their gains in accordance with control signals from the gain control unit 6c.

The 15th embodiment can prevent an input amplitude to the signal extraction circuit 15 in a steady state from excessively decreasing or increasing, even if the amplitude of a desired signal component contained in the input baseband signal changes, by adjusting the gain of the variable gain amplifier 23, as well as being able to obtain the same effects as those of the first embodiment. In addition, the 15th embodiment can adjust the follow-up response speed with respect to a DC offset variation and the behavior of overshoot at the time of follow-up operation by changing the gain of the variable gain inverting amplifier 24, and can make the overall circuit have the function of a variable gain amplifier by changing the gain of the variable gain amplifier 25.

Note that the gain control unit 6c may control the gains of the variable gain amplifier 23, variable gain inverting amplifier 24, and variable gain amplifier 25 so as to make them have a correlation, or may control the gains independently. As an example of control by making the gains have a correlation, a method of keeping the product of the gains of the variable gain amplifier 23, variable gain inverting amplifier 24, and variable gain amplifier 25 constant is available. The method of control by making the gains have a correlation can substantially change the threshold for signal extraction (transmission)/non-extraction (non-transmission) in the signal extraction circuit 15 while keeping the follow-up response speed with respect to a DC offset variation and the behavior of overshoot at the time of follow-up operation constant. Alternatively, the gain of the overall circuit can be changed while the follow-up response speed with respect to a DC offset variation, the behavior of overshoot at the time of follow-up operation, and the effective threshold for extraction (transmission)/non-extraction (non-transmission) in the signal extraction circuit 15 are kept constant.

In each of the signal processing circuits 6a according to the second to eighth embodiments, the variable gain amplifier 23 may be inserted between the low-pass filter 14 and the signal extraction circuit 15, the variable gain amplifier 25 may be used in place of the amplifier 13, and the variable gain inverting amplifier 24 (or a variable gain amplifier) may be used in place of the inverting amplifier 16 (or the amplifier 20). This makes it possible to obtain the same effects as those of the 15th embodiment.

### 16TH EMBODIMENT

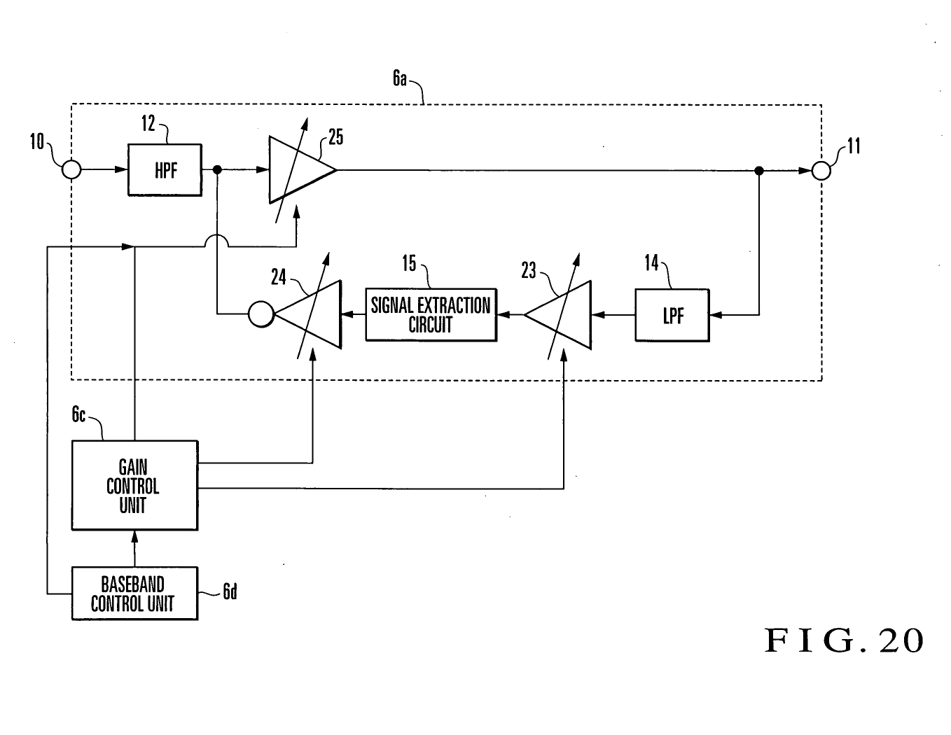

A signal processing device according to the 16th embodiment will be described next with reference to FIG. 20. FIG. 20 is a view showing a schematic arrangement example of a signal processing circuit 6a and the like of the signal processing device according to the 16th embodiment. The signal processing circuit 6a in the 16th embodiment has the same arrangement as that of the signal processing circuit 6a in the 15th embodiment. The signal processing device according to the 16th embodiment further includes a baseband control unit 6d.

In this arrangement, the baseband control unit 6d controls the gain of a variable gain amplifier 25 in accordance with the intensity of a received RF signal, and also supplies the gain setting information of the variable gain amplifier 25 to a gain control unit 6c. The gain control unit 6c calculates the gains of a variable gain amplifier 23, a variable gain inverting amplifier 24, and the variable gain amplifier 25 on the basis of the gain setting information of the variable gain amplifier 25 which is supplied from the baseband control unit 6d, and supplies control signals corresponding to the calculated gains to all or some of the variable gain amplifier 23, variable gain inverting amplifier 24, and variable gain amplifier 25, thereby performing gain control.

The 16th embodiment can optimize the follow-up response speed with respect to a DC offset variation, the behavior of overshoot at the time of follow-up operation, transient response accompanying a change in the gain of the amplifier, and the like in addition to obtaining the same effects as those of the first embodiment. Each of the signal processing devices according to the second to eighth embodiments may have an arrangement similar to that of the signal processing device according to the 16th embodiment, like the first embodiment. This makes it possible to obtain the same effects as those of the 16th embodiment.

### 17TH EMBODIMENT

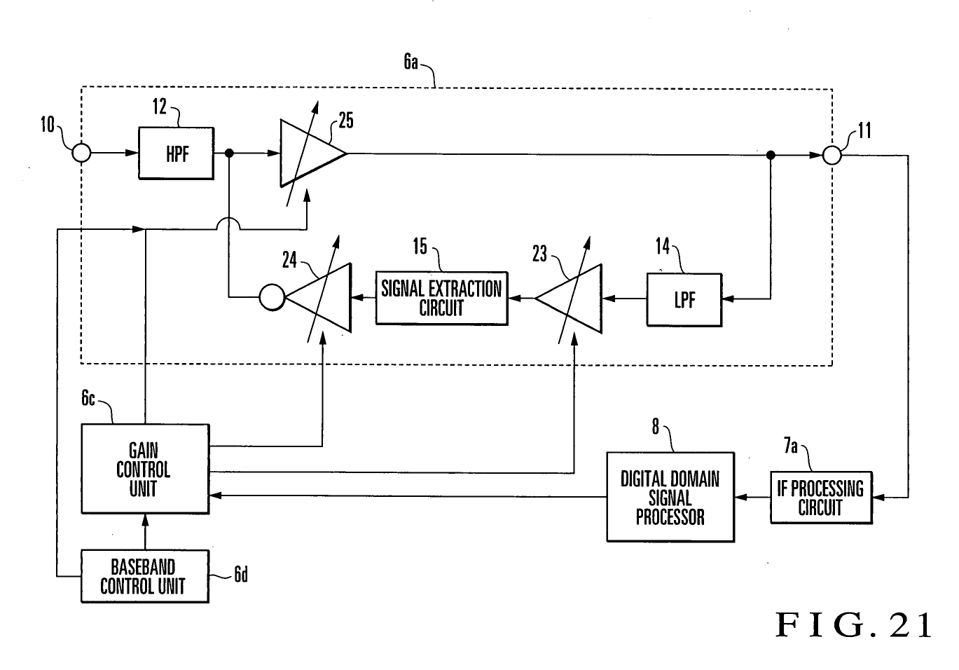

A signal processing device according to 17th embodiment will be described next with reference to FIG. 21. FIG. 21 is a view showing a schematic arrangement example of a signal processing circuit 6a and the like of the signal processing device according to the 17th embodiment. The signal processing device in the 17th embodiment has the same arrangement as that of the signal processing device in the 16th embodiment, but differs therefrom in the gain control method for each amplifier.

In this arrangement, a baseband control unit 6d controls the gain of a variable gain amplifier 25 in accordance with the intensity of a received RF signal, and supplies the gain setting information of the variable gain amplifier 25 to the gain control unit 6c. In addition, a digital domain signal processor 8 supplies bit error (obtained by detecting a signal demodulation error) rate data evaluated in signal demodulation to a gain control unit 6c.

The gain control unit 6c calculates the gains of a variable gain amplifier 23, variable gain inverting amplifier 24, and variable gain amplifier 25 so as to minimize a demodulation error on the basis of the bit error rate supplied from the digital domain signal processor 8, and supplies them as control signals to all or some of the variable gain amplifier 23, variable gain inverting amplifier 24, and variable gain amplifier 25. In addition, the gain control unit 6c calculates the gains of the variable gain amplifier 23, variable gain inverting amplifier 24, and variable gain amplifier 25 on the basis of the gain setting information of the variable gain amplifier 25 which is supplied from the baseband control unit 6d and the bit error rate information supplied from the digital domain signal processor 8, and supplies control signals corresponding to the calculated gains to all or some of the variable gain amplifier 23, variable gain inverting amplifier 24, and variable gain amplifier 25.

The 17th embodiment can optimize the follow-up response speed with respect to a DC offset variation, the behavior of overshoot at the time of follow-up operation, transient response accompanying a change in the gain of the amplifier, and the like, and reduce the bit error rate in addition to obtaining the same effects as those of the first embodiment. Each of the signal processing devices according to the second to eighth embodiments may have an arrangement similar to that of the signal processing device according to the 17th embodiment, like the first embodiment. This makes it possible to obtain the same effects as those of the 17th embodiment.

### 18TH EMBODIMENT

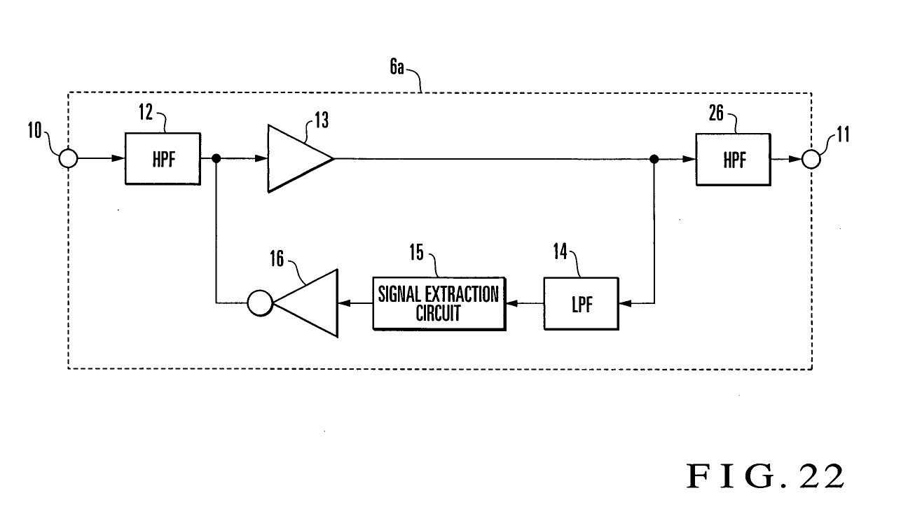

A signal processing device according to the 18th embodiment will be described next with reference to FIG. 22. FIG. 22 is a schematic arrangement example of a signal processing circuit 6a of the signal processing device according to the 18th embodiment. As shown in FIG. 22, the signal processing circuit 6a in the 18th embodiment differs from the signal processing circuit 6a in the first embodiment in that a high-pass filter 26 is inserted between the entrance of a feedback path and an output terminal 11.

In this arrangement, the characteristic of a high-pass filter 12 is selected to optimize the response characteristic of a feedback path connected thereafter, and a characteristic required to cancel a static offset can be realized by the high-pass filter 26. The 18th embodiment can therefore obtain the same effects as those of the first embodiment more efficiently. Note that in each of the signal processing circuits 6a according to the second to 17th embodiments as well, the high-pass filter 26 may be inserted between the entrance of the feedback path and the output terminal 11. This makes it possible to obtain the same effects as those of the 18th embodiment.

### 19TH EMBODIMENT

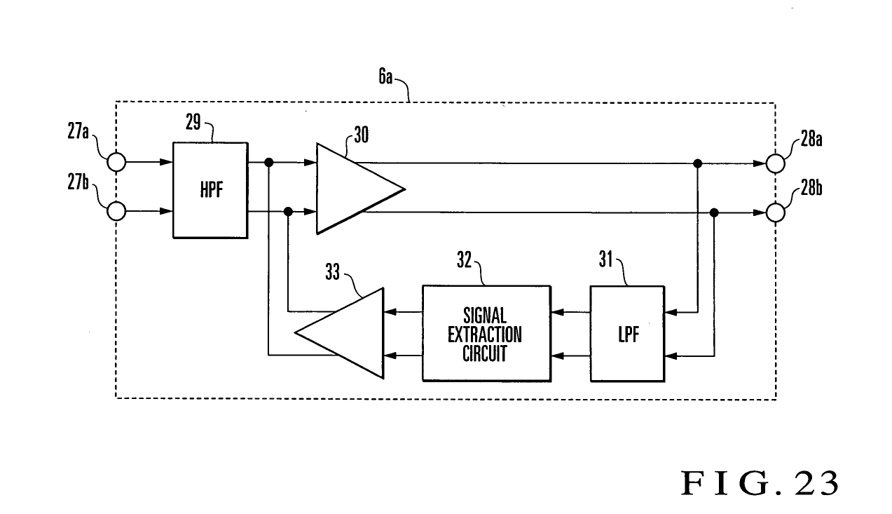

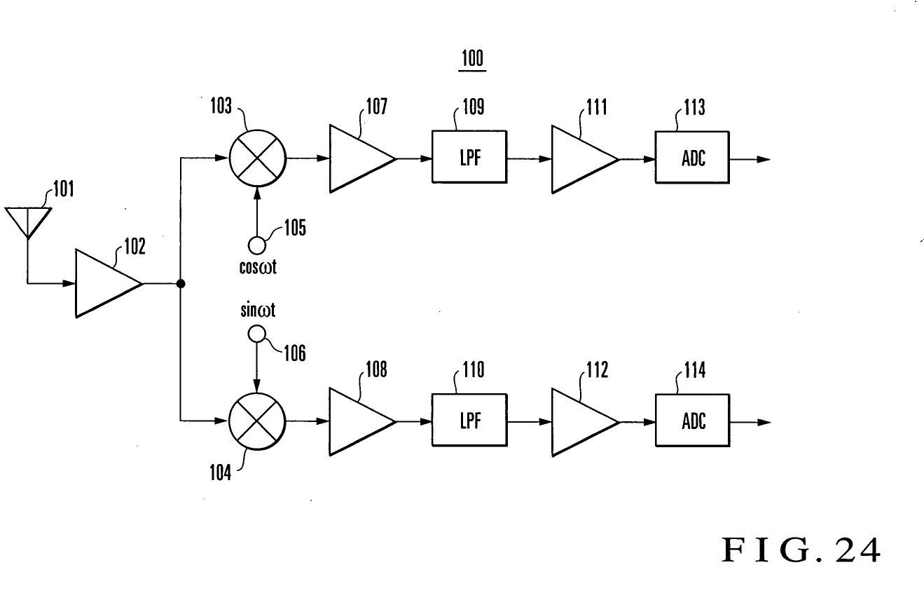

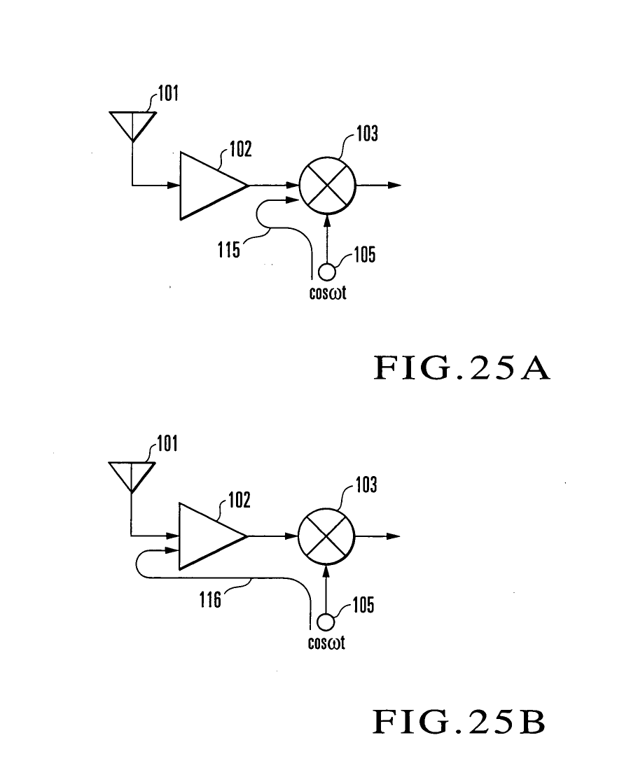

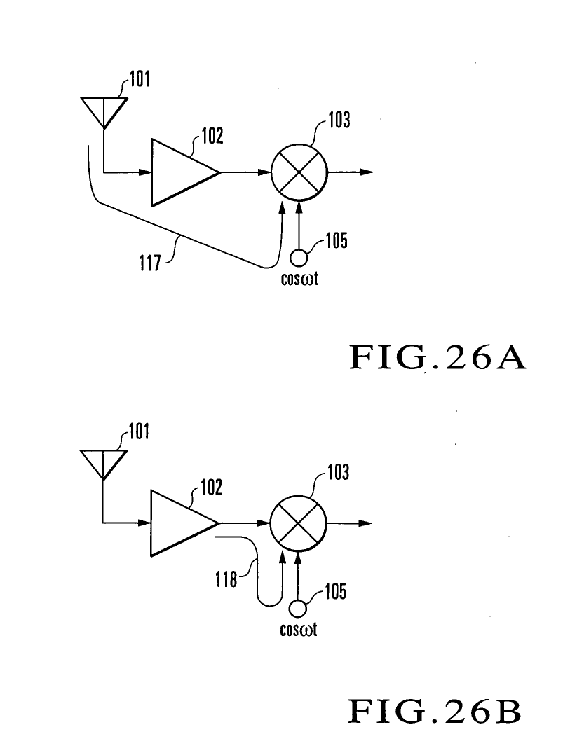

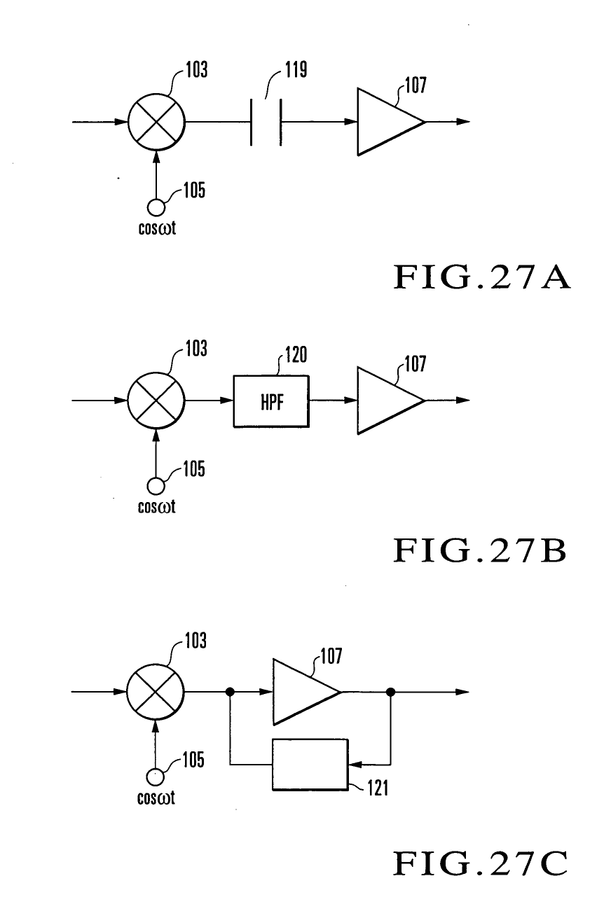

A signal processing device according to the 19th embodiment will be described next with reference to FIG. 23. FIG. 23 is a view showing a schematic arrangement example of a signal processing circuit 6a of the signal processing device according to the 19th embodiment. As shown in FIG. 23, the signal processing circuit 6a according to the 19th embodiment comprises a high-pass filter 29, amplifier 30, low-pass filter 31, signal extraction circuit 32, and amplifier 33. Each element (circuit) is provided with two inputs and two outputs to form differential signal paths. The signal processing circuit 6a in the 19th embodiment has the same function as that of the signal processing circuit 6a in the first embodiment except that each element (circuit) in the signal processing circuit 6a according to the 19th embodiment performs the same processing for two signals.

In this arrangement, identical baseband signals having different polarities are input to input terminals 27a and 27b, pass through the high-pass filter 29, and are amplified by the amplifier 30. The signals then output from output terminals 28a and 28b, and are input to the corresponding feedback paths. High-frequency components are removed from the baseband signals input to the feedback paths by the low-pass filter 31. If the voltages of the respective baseband signals fall outside a predetermined voltage range, the signal extraction circuit 32 extracts signals corresponding to voltage portions outside the voltage range. The extracted signals are amplified by the amplifier 33, and then are fed back to the corresponding signal paths (i.e., negatively fed back). This cancels out the signal components extracted from the respective baseband signals passing through the high-pass filter 29 by the signal extraction circuit 32, thereby regulating the direct current potentials of the baseband signals.

With the arrangement of the 19th embodiment, the same effects as those of the first embodiment can be obtained. Note that in each of the signal processing circuits 6a according to the second to 18th embodiments, all the signal paths may be formed into differential paths. This makes it possible to obtain the same effects as those of the.19th embodiment.

Embodiments of the present invention have been described above. However, the specific arrangements of the present invention are not limited to those of the first to 19th embodiments. Even changes in design and the like within the spirit and scope of the present invention are incorporated in the present invention.

In the first to 19th embodiments, the present invention is realized by feedback-type circuit (feedback circuit) arrangements. However, the present invention can be realized by feedforward-type circuit arrangements. In addition, in each embodiment described above, the signal processing device of the present invention is applied to the direct conversion reception device. However, the present invention is not limited to this, and can be applied to any reception device which needs to meet both the requirement for processing of a dynamic DC offset and the requirement for signal transmission without any omission of a desired signal component with a simple arrangement.

As has been described above, according to the above embodiments, if the voltage of a signal to be processed falls outside a predetermined voltage range, the extraction means comprising the signal extraction means and the like extracts a signal corresponding to a voltage portion outside the voltage range, and the regulation means comprising the direct current potential regulation means and the like regulates the direct current potential of the signal to be processed on the basis of the extracted signal, thereby meeting the requirement for transmission without any omission of a desired signal component and the requirement for processing of a dynamic offset.

1. A signal processing device which includes an input unit which inputs a signal, a signal processing unit which processes the input signal, and an output unit which outputs the processed signal, characterized in that
the signal processing unit comprises direct current component cutoff means for cutting off a direct current component of the input signal, signal extraction means for extracting a signal corresponding to a voltage portion in which a voltage of a signal passing through said direct current component cutoff means falls outside a predetermined voltage range, and direct current potential regulation means for regulating and outputting a direct current potential of a processing target signal on the basis of the extracted signal.

2. A signal processing device according to claim 1, characterized in that
said signal processing unit comprises an output path extending from said input unit to said output unit, and a feedback path feeding back from said output unit to an output node of said direct current component cutoff means,
said signal extraction means is inserted in the feedback path, and
said direct current potential regulation means is inserted in the output path.

3. A signal processing device according to claim 1, characterized in that said direct current potential regulation means comprises first variable gain means having a variable gain.

4. A signal processing device according to claim 1, characterized in that said signal processing unit further comprises second gain variable means which is inserted between said signal extraction means and said direct current potential regulation means and has a variable gain.

5. A signal processing device according to claim 1, characterized in that
said direct current potential regulation means comprises first variable gain means having a variable gain, and
said signal processing unit further comprises second gain variable means which is inserted between said signal extraction means and said direct current potential regulation means and has a variable gain.

6. A signal processing device according to claim 2, characterized in that
said signal processing unit further comprises high-frequency component removal means for removing a high-frequency component of a signal input to the feedback path, and
if a voltage of the signal from which the high-frequency component is removed falls outside a predetermined voltage range, said signal extraction means extracts a signal corresponding to a voltage portion outside the voltage range.

7. A signal processing device according to claim 6, characterized in that said signal processing unit further comprises third variable gain means which is inserted between said high-frequency component removal means and said signal extraction means and has a variable gain.

8. A signal processing device according to claim 6, characterized in that
said direct current potential regulation means comprises first variable gain means having a variable gain, and
said signal processing unit further comprises third variable gain means which is inserted between said high-frequency component removal means and said signal extraction means and has a variable gain.

9. A signal processing device according to claim 6, characterized in that
said signal processing unit further comprises second gain variable means which is inserted between said signal extraction means and said direct current potential regulation means and has a variable gain, and third variable gain means which is inserted between said high-frequency component removal means and said signal extraction means and has a variable gain.

10. A signal processing device according to claim 6, characterized in that
said direct current potential regulation means comprises first variable gain means having a variable gain, and
said signal processing unit further comprises second gain variable means which is inserted between said signal extraction means and said direct current potential regulation means and has a variable gain, and third variable gain means which is inserted between said high-frequency component removal means and said signal extraction means and has a variable gain.

11. A signal processing device according to claim 1, characterized in that
said signal processing unit further comprises inverting means for inverting a polarity of the extracted signal, and
said direct current potential regulation means regulates a direct current potential of a signal passing through said direct current component cutoff means on the basis of the inverted signal.

12. A signal processing device according to claim 1, characterized in that
said signal processing unit further comprises inverting means for inverting a polarity of a signal passing through said direct current component cutoff means, and
if a voltage of the inverted signal falls outside a predetermined voltage range, said signal extraction means extracts a signal corresponding to a voltage portion outside the voltage range.

13. A signal processing device according to claim 2, characterized in that the feedback path is a negative feedback path.

14. A signal processing device according to claim 1, characterized in that said direct current potential regulation means regulates a direct current potential of a signal passing through said direct current component cutoff means by canceling out the signal component extracted from the signal.

15. A signal processing device according to claim 1, characterized in that said direct current potential regulation means regulates a direct current potential of a signal passing through said direct current component cutoff means by obtaining a difference between the signal and the extracted signal.

16. A signal processing device according to claim 1, characterized in that a low cutoff frequency with respect to a transfer function from an output node of said direct current component cutoff means to said output unit is higher than a low cutoff frequency of said direct current component cutoff means when the voltage falls outside a predetermined voltage range.

17. A signal processing device according to claim 1, characterized in that the cutoff frequency of said direct current component cutoff means is selected to be low enough to neglect an influence of omission of a desired signal component.

18. A signal processing device according to claim 1, characterized in that
said direct current potential regulation means comprises integration means for integrating the extracted signal, and regulates a direct current potential of the input signal on the basis of the integrated signal.

19. A signal processing device according to claim 18, characterized in that
said signal processing unit comprises an output path extending from said input unit to said output unit, and an feedback path feeding back from said output unit to an output node of said direct current component cutoff means,
said extraction means is inserted in the feedback path, and
said direct current potential regulation means is inserted in the output path.

20. A signal processing device according to claim 18, characterized in that said direct current potential regulation means comprises first variable gain means having a variable gain.

21. A signal processing device according to claim 18, characterized in that said signal processing unit further comprises second variable gain means which is inserted between said signal extraction means and said direct current potential regulation means and has a variable gain.

22. A signal processing device according to claim 18, characterized in that
said direct current potential regulation means comprises first variable gain means having a variable gain, and
said signal processing unit further comprises second gain variable means which is inserted between said signal extraction means and said direct current potential regulation means and has a variable gain.

23. A signal processing device according to claim 19, characterized in that
said signal processing unit further comprises high-frequency component removal means for removing a high-frequency component of a signal input to the feedback path, and
when a voltage of the signal from which the high-frequency component is removed falls outside a predetermined voltage range, said signal extraction means extracts a signal corresponding to a voltage portion outside the voltage range.

24. A signal processing device according to claim 23, characterized in that said signal processing unit further comprises third variable gain means which is inserted between said high-frequency component removal means and said signal extraction means and has a variable gain.

25. A signal processing device according to claim 23, characterized in that
said direct current potential regulation means comprises first variable gain means having a variable gain, and
said signal processing unit further comprises third variable gain means which is inserted between said high-frequency component removal means and said signal extraction means and has a variable gain.

26. A signal processing device according to claim 23, characterized in that
said signal processing unit further comprises second gain variable means which is inserted between said signal extraction means and said direct current potential regulation means and has a variable gain, and third variable gain means which is inserted between said high-frequency component removal means and said signal extraction means and has a variable gain.

27. A signal processing device according to claim 23, characterized in that
said direct current potential regulation means comprises first variable gain means having a variable gain, and
said signal processing unit further comprises second gain variable means which is inserted between said signal extraction means and said direct current potential regulation means and has a variable gain, and third variable gain means which is inserted between said high-frequency component removal means and said signal extraction means and has a variable gain.

28. A signal processing device according to claim 5, characterized by further comprising a gain control unit which performs gain control for at least one of said first variable gain means and said second variable gain means such that a product of gains of said first variable gain means and said second variable gain means becomes constant.

29. A signal processing device according to claim 8, characterized by further comprising a gain control unit which performs gain control for at least one of said first variable gain means and said third variable gain means such that a product of gains of said first variable gain means and said third variable gain means becomes constant.

30. A signal processing device according to claim 9, characterized by further comprising a gain control unit which performs gain control for at least one of said second variable gain means and said third variable gain means such that a product of gains of said second variable gain means and said third variable gain means becomes constant.

31. A signal processing device according to claim 10, characterized by further comprising a gain control unit which performs gain control for at least one of said first variable gain means, said second variable gain means, and said third variable gain means such that a product of gains of said first variable gain means, said second variable gain means, and said third variable gain means becomes constant.

32. A signal processing device according to claim 3, characterized by further comprising:
a demodulation control unit which performs signal demodulation and detects a signal demodulation error on the basis of the signal output from said output unit; and
a gain control unit which performs gain control for said first variable gain means so as to minimize the detected signal demodulation error.

33. A signal processing device according to claim 4, characterized by further comprising:
a demodulation control unit which performs signal demodulation and detects a signal demodulation error on the basis of the signal output from said output unit; and
a gain control unit which performs gain control for said second variable gain means so as to minimize the detected signal demodulation error.

34. A signal processing device according to claim 7, characterized by further comprising:
a demodulation control unit which performs signal demodulation and detects a signal demodulation error on the basis of the signal output from said output unit; and
a gain control unit which performs gain control for said third variable gain means so as to minimize the detected signal demodulation error.

35. A signal processing device according to claim 18, characterized in that
said signal processing unit further comprises inverting means for inverting a polarity of the extracted signal, and
said integration means integrates the inverted signal.

36. A signal processing device according to claim 18, characterized in that
said signal processing unit further comprises inverting means for inverting a polarity of the integrated signal, and
said direct current potential regulation means regulates a direct current potential of the input signal on the basis of the inverted signal.

37. A signal processing device according to claim 19, characterized in that the feedback path is a negative feedback path.

38. A signal processing device according to claim 18, characterized in that said direct current potential regulation means regulates a direct current potential of the input signal by canceling out the signal component extracted from the signal.

39. A signal processing device according to claim 18, characterized in that said direct current potential regulation means regulates a direct current potential of the input signal by obtaining a difference between the input signal and the extracted signal.

40. A signal processing device according to claim 1, characterized in that the predetermined voltage range is set such that a voltage of the signal in a steady state falls within the voltage range.

41. A signal processing device according to claim 1, characterized in that said extraction means comprises diodes connected in anti-parallel.

42. A signal processing device according to claim 1, characterized in that said extraction means comprises an N-type MOSFET and P-type MOSFET, and is configured such that a gate of said N-type MOSFET is connected to a gate of said P-type MOSFET, and a source of said N-type MOSFET is connected to a source of said P-type MOSFET.

43. A direct conversion reception device characterized by comprising:
mixing means for frequency-mixing a received high-frequency signal and an oscillation signal and converting the resultant signal into a baseband signal;
extraction means for extracting a signal corresponding to a voltage portion outside a predetermined voltage range from the baseband signal; and
regulation means for regulating a direct current potential of the baseband signal on the basis of the extracted signal.
